(19) United States
(12) Patent Application Publication
(10) Pub. No.: US 2019/0114563 A1
(43) Pub. Date: Apr. 18, 2019

(54) PASSENGER MANAGEMENT APPARATUS AND PASSENGER MANAGEMENT METHOD

(71) Applicant: SUBARU CARBELL CO.,LTD., Osaka (JP)

(72) Inventor: Toshihiro YUKIMOTO, Osaka (JP)

(73) Assignee: SUBARU CARBELL CO.,LTD., Osaka (JP)

(21) Appl. No.: 16/090,368

(22) PCT Filed: Dec. 22, 2017
(86) PCT No.: PCT/JP2017/046067

§ 371 Date: Oct. 1, 2018

(30) Foreign Application Priority Data
Dec. 26, 2016 (JP) 2016-250346

(51) Int. Cl. G06Q 10/02; G06Q 50/30; G06K 9/00

(52) U.S. Cl. CPC G06Q 10/02; G06K 9/00295; G06K 9/00778; G06Q 50/30

(57) ABSTRACT

A passenger management apparatus can appropriately manage the return state and number of passengers and prevent getting-on of a person not scheduled to get on such as a suspicious person.

### TECHNICAL FIELD

The present invention relates to a passenger management apparatus and a passenger management method, and more particularly, to a passenger management apparatus and a passenger management method for managing passengers of a transportation means (e.g., a bus) which can transport a large number of people.

### BACKGROUND ART

In cases where a large number of people travel around a sightseeing course together, a bus is often used. In the case of long-distance travel by bus, a rest is sometimes taken at a spot where there are toilets such as a service area. And a free time during which passengers can act freely at a popular tourist site and the like is sometimes scheduled.

When a rest period or a free time is taken, a bus tour conductor informs passengers of a departure time, and the passengers need return to the bus by the time. At the departure time, the tour conductor checks a return state of the passengers, and after confirming the return of all the passengers to the bus, the bus is to start to the next destination.

In the case of a great number of passengers, this confirmation work is not easy. For example, it takes effort and time to call the names with checking a passenger list. Therefore, techniques for effectively conducting this confirmation work have been proposed (see, for example, the below-mentioned Patent Documents 1 and 2).

### Problems to be Solved by the Invention

In the inventions described in Patent documents 1 and 2, the getting-on/-off of a passenger is managed by exchanging radio signals between a tag (an IC tag) which the passenger holds and a device mounted on a bus. However, since tags for every passenger must be prepared, it costs much to construct the system. And if the passenger left behind the tag in the bus (on the seat), or somewhere outside the bus, it is impossible to correctly manage the passenger's getting-on/-off.

In case where a person illegally comes in to take the place of some passenger on the way and the person traveling illegally holds the passenger's tag, the replacement of passengers cannot be detected, that is, it cannot be detected that a suspicious person got on the bus on the way.

### PRIOR ART DOCUMENT

### Patent Document

Patent Document 1: Japanese Patent Application Laid-Open Publication No. 2004-252909

Patent Document 2: Japanese Patent Application Laid-Open Publication No. 2004-139459

### SUMMARY OF THE INVENTION

### Means for Solving Problem and the Effect

The present invention was developed in order to solve the above problems, and it is an object of the present invention to provide a passenger management apparatus and a passenger management method, whereby it is possible to appropriately manage a return state of passengers and the number of persons on board (the number of passengers) without asking the passengers to hold an IC tag and the like, and to prevent a person not scheduled to get on (such as a suspicious person) from getting on, or prevent a passenger from getting on a wrong bus.

In order to achieve the above object, a passenger management apparatus according to a first aspect of the present invention is characterized by managing passengers of a transportation means which can transport a large number of people, said passenger management apparatus comprising:

one or more getting-on passenger imaging parts for picking up an image of a passenger getting on;

one or more getting-off passenger imaging parts for picking up an image of a passenger getting off;

a getting-on passenger image storing part for associating to store the image including a face of the passenger getting on picked up by the getting-on passenger imaging part with the image's picked-up time;

a getting-off passenger image storing part for associating to store the image including a face of the passenger getting off picked up by the getting-off passenger imaging part with the image's picked-up time;

a passenger number detecting part for detecting the number of persons on board, on the basis of information stored in the getting-on passenger image storing part and the getting-off passenger image storing part;

a getting-on/-off passenger comparing part for comparing a passenger who got off after getting-on with a passenger getting on after getting-off, on the basis of the information stored in the getting-on passenger image storing part and the getting-off passenger image storing part;

a passenger number informing part for informing the number of passengers detected by the passenger number detecting part; and

a comparison result informing part for informing a result of comparison by the getting-on/-off passenger comparing part.

Using the passenger management apparatus according to the first aspect of the present invention, based on the image and the picked-up time thereof stored in the getting-on passenger image storing part, and the image and the picked-up time thereof stored in the getting-off passenger image storing part, the number of persons on board (the number of passengers) can be continuously managed. And by comparing the images of the passengers who got off after getting-on with the images of the passengers getting on after getting-off, the return state of the passengers can be appropriately managed without asking the passengers to hold a device for exclusive use such as an IC tag. Consequently, it is possible to prevent a person different from the passengers who got off after getting-on such as a suspicious person from getting on, leading to maintaining the safety of passengers.

The passenger management apparatus according to a second aspect of the present invention is characterized by further comprising a biometric identification information acquiring part for acquiring biometric identification information of passengers, wherein

the getting-on passenger image storing part associates to store biometric identification information of the passenger getting on, as well as the image, with the image's picked-up time, and

the getting-off passenger image storing part associates to store biometric identification information of the passenger getting off, as well as the image, with the image's picked-up time in the passenger management apparatus according to the first aspect of the present invention.

Using the passenger management apparatus according to the second aspect of the present invention, in the detection of the number of passengers by the passenger number detecting part or in the comparison of getting-on/-off passengers by the getting-on/-off passenger comparing part, the biometric identification information of the getting-on/-off passengers as well as the images can be used, and therefore, the detection accuracy of the number of passengers and the comparison accuracy of passengers when the passengers return can be further enhanced. The biometric identification information includes a fingerprint, a venous pattern, a retina, a voice (a voiceprint) and the like, and at least one piece of information selected from among them can be used.

The passenger management apparatus according to a third aspect of the present invention is characterized by further comprising:

a getting-on passenger stereoscopic image forming part for forming a stereoscopic image of the getting-on passenger using a plurality of images picked up from two or more directions by the getting-on passenger imaging parts; and

a getting-off passenger stereoscopic image forming part for forming a stereoscopic image of the getting-off passenger using a plurality of images picked up from two or more directions by the getting-off passenger imaging parts, wherein

the getting-on passenger image storing part associates to store the stereoscopic image of the getting-on passenger formed by the getting-on passenger stereoscopic image forming part with the images' picked-up time,

the getting-off passenger image storing part associates to store the stereoscopic image of the getting-off passenger formed by the getting-off passenger stereoscopic image forming part with the images' picked-up time, and

the getting-on/-off passenger comparing part compares the stereoscopic image of the passenger who got off after getting-on with the stereoscopic image of the passenger getting on after getting-off in the passenger management apparatus according to the first aspect of the present invention.

Using the passenger management apparatus according to the third aspect of the present invention, the stereoscopic image of the passenger who got off after getting-on is compared with the stereoscopic image of the passenger getting on after getting-off by the getting-on/-off passenger comparing part. Consequently, compared to the case of comparison of plane images, the comparison accuracy can be improved to a probability of nearly 100%.

The passenger management apparatus according to a fourth aspect of the present invention is characterized by further comprising:

a passenger information associating part for associating the information stored in the getting-on passenger image storing part and the getting-off passenger image storing part, with passenger information including a name and a seat position of a passenger;

a vacant seat information detecting part for detecting the positions and number of vacant seats of the transportation means, on the basis of the information associated by the passenger information associating part;

a vacant seat information informing part for informing the positions and/or number of vacant seats detected by the vacant seat information detecting part;

a vacant seat number judging part for judging whether the number of vacant seats detected by the vacant seat information detecting part is correct in relation to the number of passengers detected by the passenger number detecting part; and a judgment result informing part for informing a judgment result by the vacant seat number judging part in the passenger management apparatus according to any one of the first to third aspects of the present invention.

Using the passenger management apparatus according to the fourth aspect of the present invention, the image of the getting-on passenger and the image of the getting-off passenger, and the name and seat position of the passenger are associated (bound). As a result, not only the number of passengers, but also the positions and number of vacant seats can be managed. Furthermore, whether the number of vacant seats is correct in relation to the number of passengers is judged, and the judgment result is informed. Therefore, in a case where the number of vacant seats is not correct in relation to the number of passengers, a crew member can smoothly check the number of passengers, and can confirm some omission or double detection in the number of passengers at once.

The passenger management apparatus according to a fifth aspect of the present invention is characterized by further comprising:

a comparison instruction data sending part for sending comparison instruction data including the image picked up by the getting-on passenger imaging part to a passenger information database server in which passenger information including names, seat positions and face images of passengers is registered; and

a comparison result receiving part for receiving a comparison result of the image and the passenger information compared in the passenger information database server, wherein

the passenger information associating part associates the name and seat position of the passenger received from the passenger information database server with the image picked up by the getting-on passenger imaging part, when the comparison result shows a match, in the passenger management apparatus according to the fourth aspect of the present invention.

Using the passenger management apparatus according to the fifth aspect of the present invention, the comparison instruction data including the image is sent to the passenger information database server, and from the passenger information database server, the comparison result is received. When the comparison result shows that there is a match, the name and seat position of the passenger received from the passenger information database server and the image picked up by the getting-on passenger imaging part are associated. As a result, when a passenger gets on the transportation means at the point of departure and the like, even if a crew member does not directly check the name of the passenger or a passenger ticket thereof, the passenger information (the name and seat position of the passenger) can be automatically associated with the passenger using a picked-up image thereof.

The passenger management apparatus according to a sixth aspect of the present invention is characterized by further comprising:

a passenger information storing part for storing passenger information including a name and a seat position of a passenger;

a comparison instruction data sending part for sending comparison instruction data including the image picked up by the getting-on passenger imaging part to a personal information database server in which personal information including names and face images of individuals is registered; and

a comparison result receiving part for receiving a comparison result of the image and the personal information compared in the personal information database server, wherein

the passenger information associating part compares the name of an individual included in the comparison result when the comparison result shows a match, with the names of the passengers stored in the passenger information storing part, and associates the name and seat position of the passenger that matched in the comparison with the image picked up by the getting-on passenger imaging part in the passenger management apparatus according to the fourth aspect of the present invention.

Using the passenger management apparatus according to the sixth aspect of the present invention, the comparison instruction data including the image is sent to the personal information database server, and from the personal information database server, the comparison result is received. When the comparison result shows that there is a match, the name of the individual included in the comparison result and the names of the passengers stored in the passenger information storing part are compared, and the name and seat position of the passenger that matched in the comparison and the image picked up by the getting-on passenger imaging part are associated. As a result, when a passenger gets on the transportation means at the point of departure and the like, even if a crew member does not directly check the name of the passenger or a passenger ticket thereof, the passenger information (the name of the passenger) can be automatically associated with the passenger using a picked-up image thereof.

The passenger management apparatus according to a seventh aspect of the present invention is characterized by further comprising:

a request signal sending part for sending a position information request signal to a portable terminal device of a passenger who did not return by an expected time, on the basis of the comparison result by the getting-on/-off passenger comparing part;

a position information receiving part for receiving position information sent from the portable terminal device which received the position information request signal; and

a position information informing part for informing the received position information in the passenger management apparatus according to any one of the first to sixth aspects of the present invention.

Using the passenger management apparatus according to the seventh aspect of the present invention, a position information request signal is sent to the portable terminal device of the passenger who did not return by the expected time, the position information sent from the portable terminal device is received, and the received position information is informed. Consequently, a crew member can grasp the position of the passenger who did not return by the expected time. And by receiving the position information time by time, it is also possible to grasp the state of return of the passenger who has not yet returned.

The passenger management apparatus according to an eighth aspect of the present invention is characterized by further comprising:

a position information receiving part for receiving position information sent from a portable terminal device of a passenger;

a return judging part for judging whether the passenger can return to the transportation means by an expected time on the basis of the received position information; and

a call signal sending part for sending a call signal, when it is judged that the passenger cannot return by the expected time by the return judging part, to the portable terminal device of the passenger who cannot return in the passenger management apparatus according to any one of the first to sixth aspects of the present invention.

Using the passenger management apparatus according to the eighth aspect of the present invention, in a case where it is judged that the passenger cannot return by the expected time, a call signal is sent to the portable terminal device of the passenger who cannot return. Therefore, timing of sending the call signal can be controlled depending on the position of the passenger who has not yet returned so as to send a call with appropriate timing. A long delay of the return of the passenger can be prevented.

The passenger management apparatus according to a ninth aspect of the present invention is characterized by further comprising:

a baggage information registering part for registering information of baggage left by a passenger;

a baggage judging part for judging, when a passenger who did not return by an expected time is detected on the basis of a comparison result by the getting-on/-off passenger comparing part, whether there is baggage of the passenger who did not return by the expected time on the basis of the information of baggage registered in the baggage information registering part; and

a baggage informing part for informing, when it is judged that there is baggage of the passenger who did not return by the expected time by the baggage judging part, that the baggage of the passenger should be checked or removed in the passenger management apparatus according to any one of the first to eighth aspects of the present invention.

Using the passenger management apparatus according to the ninth aspect of the present invention, in a case where the passenger who did not return by the expected time is detected, on the basis of the information of baggage registered in the baggage information registering part, whether there is baggage of the passenger who did not return is judged. When it is judged that there is baggage of the passenger who did not return, it is informed that the passenger's baggage should be checked or removed. Therefore, in case where the baggage of the passenger who did not return is a suspicious substance, it becomes possible to swiftly remove the baggage to the outside of the transportation means. As a result, the safety of the other passengers can be secured and it is possible to prevent an accident from being caused by the suspicious substance.

The passenger management apparatus according to a tenth aspect of the present invention is characterized by further comprising:

a suspicious person comparison result informing part for informing, when the comparison result shows no match, a comparison result of the image including the face of the passenger with suspicious person image registration information; and

a reporting part for reporting to the outside when a result that the passenger with no match is a suspicious person is informed by the suspicious person comparison result informing part, in the passenger management apparatus according to any one of the first to ninth aspects of the present invention.

Using the passenger management apparatus according to the tenth aspect of the present invention, in a case where the comparison result shows that there is no match, the comparison result of the image including the face of the passenger with the suspicious person image registration information is informed and also reported to the outside. Therefore, since the crew member can grasp boarding of the suspicious person at once, a measure for securing the safety of passengers can be quickly taken. And by reporting to the outside emergency report organization (such as the police or a security company), security guards and the like can hurry to the spot, leading to early holding of the suspicious person.

A passenger management method according to the present invention is characterized by being a method for managing passengers of a transportation means which can transport a large number of people, comprising the steps of:

picking up an image of a passenger getting on using one or more getting-on passenger imaging parts;

picking up an image of a passenger getting off using one or more getting-off passenger imaging parts;

associating to store the image including a face of the passenger getting on picked up by the getting-on passenger imaging part with the image's picked-up time in a getting-on passenger image storing part;

associating to store the image including a face of the passenger getting off picked up by the getting-off passenger imaging part with the image's picked-up time in a getting-off passenger image storing part;

detecting the number of passengers on board on the basis of information stored in the getting-on passenger image storing part and the getting-off passenger image storing part;

comparing a passenger who got off after getting-on with a passenger getting on after getting-off on the basis of the information stored in the getting-on passenger image storing part and the getting-off passenger image storing part;

informing the number of passengers detected in the step of detecting the number of passengers; and

informing a result of comparison in the step of comparing the getting-on/-off passengers.

In the above passenger management method, on the basis of the image and its picked-up time stored in the getting-on passenger image storing part, and the image and its picked-up time stored in the getting-off passenger image storing part, the number of persons on board (the number of passengers) can be continuously managed. And by comparing the images of the passengers who got off after getting-on with the images of the passengers getting on after getting-off, the return state of the passengers can be appropriately managed without asking the passengers to hold a device for exclusive use such as an IC tag. Furthermore, it is possible to prevent a person different from the passengers getting off after getting-on, for example, a suspicious person from getting on, leading to securing the safety of passengers.

### BRIEF DESCRIPTION OF DRAWINGS

FIG. 1 is a block diagram schematically showing a construction of a passenger management apparatus according to an embodiment (1) of the present invention;

FIG. 2 is a flowchart showing processing operations conducted by a microcomputer in the passenger management apparatus according to the embodiment (1);

FIG. 3A is a flowchart showing processing operations conducted by the microcomputer in the passenger management apparatus according to the embodiment (1);

FIG. 3B is a flowchart showing processing operations conducted by the microcomputer in the passenger management apparatus according to the embodiment (1);

FIG. 4 is a block diagram schematically showing a construction of a passenger management apparatus according to an embodiment (2);

FIG. 5 is a flowchart showing processing operations conducted by a microcomputer in the passenger management apparatus according to the embodiment (2);

FIG. 6 is a flowchart showing processing operations conducted by the microcomputer in the passenger management apparatus according to the embodiment (2);

FIG. 7 is a flowchart showing processing operations conducted by the microcomputer in the passenger management apparatus according to the embodiment (2);

FIG. 8 is a block diagram schematically showing a construction of a passenger management apparatus according to an embodiment (3);

FIG. 9 is a flowchart showing processing operations conducted by a microcomputer in the passenger management apparatus according to the embodiment (3);

FIG. 10A is a flowchart showing processing operations conducted by the microcomputer in the passenger management apparatus according to the embodiment (3);

FIG. 10B is a flowchart showing processing operations conducted by the microcomputer in the passenger management apparatus according to the embodiment (3);

FIG. 11 is a block diagram schematically showing a construction of a passenger management apparatus according to an embodiment (4);

FIG. 12 is a flowchart showing processing operations conducted by a microcomputer in the passenger management apparatus according to the embodiment (4);

FIG. 13 is a flowchart showing processing operations conducted by the microcomputer in the passenger management apparatus according to the embodiment (4);

FIG. 14 is a flowchart showing processing operations conducted by the microcomputer in the passenger management apparatus according to the embodiment (4);

FIG. 15 is a block diagram schematically showing a construction of a passenger management apparatus according to an embodiment (5);

FIG. 16 is a flowchart showing processing operations conducted by a microcomputer in the passenger management apparatus according to the embodiment (5);

FIG. 17 is a flowchart showing processing operations conducted by the microcomputer in the passenger management apparatus according to the embodiment (5);

FIG. 18 is a block diagram schematically showing a construction of a passenger management apparatus according to an embodiment (6);

FIG. 19 is a flowchart showing processing operations conducted by a microcomputer in the passenger management apparatus according to the embodiment (6); and

FIG. 20 is a flowchart showing processing operations conducted by the microcomputer in the passenger management apparatus according to the embodiment (6).

### MODE FOR CARRYING OUT THE INVENTION

The embodiments of the passenger management apparatus and the passenger management method according to the present invention are described below by reference to the Figures. The below-described embodiments are preferred embodiments of the present invention, and various technically preferred limitations are included. However, the technical scope of the present invention is not limited to these modes, as far as there is no description particularly limiting the present invention in the following explanations.

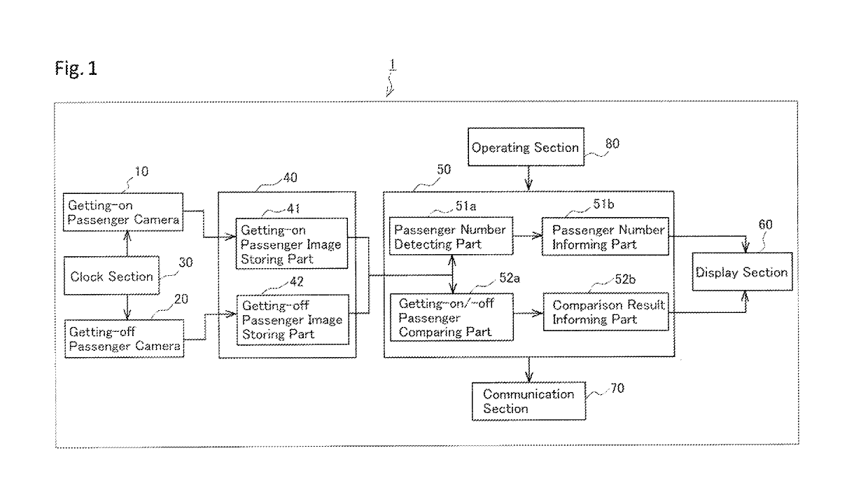

FIG. 1 is a block diagram schematically showing a construction of a passenger management apparatus 1 according to an embodiment (1). In every embodiment described below, a passenger management apparatus whereby passengers participating in a tour in which they move by one or more buses (transportation means) are managed is described. The transportation means is not limited to vehicles such as buses. This apparatus can be also used for managing passengers of a transportation means such as a ship or an airplane which can transport a large number of people. In a case where they move by a plurality of buses, a construction wherein the passenger management apparatus 1 is mounted on every bus and these plural passenger management apparatuses 1 exchange information of every kind through communications (a construction wherein these apparatuses can work in cooperation) may be also adopted.

The passenger management apparatus 1 according to the embodiment (1) comprises a getting-on passenger camera 10, a getting-off passenger camera 20, a clock section 30, a storage section 40, a microcomputer 50, a display section 60, a communication section 70, and an operating section 80.

The getting-on passenger camera 10 is a camera for picking up an image of a passenger getting on, while the getting-off passenger camera 20 is a camera for picking up an image of a passenger getting off. Each of them, comprising a lens part, an imaging element such as a CCD sensor or a CMOS sensor, an image processing part, a storage part (none of them shown) and associated parts, can take moving images or still images. The image processing part consists of an image processor having a person detecting function whereby faces of persons are individually detected and the like. The person detecting function consists of, for example, a function wherein a person's face (an area matching a face) is detected in a picked-up image, feature points such as eyes, a nose and the ends of a mouth are extracted from the face image area, and with these feature points, the person's face is individually detected.

The getting-on passenger camera 10 is placed, for example, at a position near the entrance of a bus, where a face of a passenger getting on can be photographed. The getting-off passenger camera 20 is placed, for example, at a position near the exit of the bus, where a face of a passenger getting off can be photographed. Each of the getting-on passenger camera 10 and the getting-off passenger camera 20 may consist of two or more cameras. Or one camera may be used as both the getting-on passenger camera 10 and the getting-off passenger camera 20. Or one or more in-vehicle cameras mounted as a drive recorder which photographs the inside or outside of the vehicle, or as a vehicle periphery monitoring device may also serve as the getting-on passenger camera 10 and the getting-off passenger camera 20.

The clock section 30 comprises a clock circuit, having a function of recording the time when an image was picked up by the getting-on passenger camera 10 or the getting-off passenger camera 20.

The storage section 40 comprises a getting-on passenger image storing part 41 and a getting-off passenger image storing part 42. In the getting-on passenger image storing part 41, an image including a face of a passenger getting on picked up by the getting-on passenger camera 10 and its picked-up time are associated and stored. In the getting-off passenger image storing part 42, an image including a face of a passenger getting off picked up by the getting-off passenger camera 20 and its picked-up time are associated and stored. The storage section 40 may consist of, for example, one or more semiconductor memories such as flush memories or a hard disk device, and not only an internal memory but also an external memory may be applied.

The microcomputer 50 has a function of conducting various kinds of computation processing and information processing, comprising one or more processors (CPUs), a RAM, a ROM and the like. The microcomputer 50 has functions as a passenger number detecting part 51a for detecting the number of persons on board on the basis of information stored in the getting-on passenger image storing part 41 and the getting-off passenger image storing part 42, and a passenger number informing part 51b for displaying the number of passengers detected by the passenger number detecting part 51a on the display section 60. In addition, it has functions as a getting-on/-off passenger comparing part 52a for comparing a passenger who got off after getting-on with a passenger getting on after getting-off (image recognition processing) on the basis of the information stored in the getting-on passenger image storing part 41 and the getting-off passenger image storing part 42, and a comparison result informing part 52b for displaying the result of comparison in the getting-on/-off passenger comparing part 52a on the display section 60. In the microcomputer 50, programs and data for implementing each of these functions are stored. As the getting-on/-off passenger comparing part 52a, an image identification (face identification) system into which artificial intelligence (AI) is incorporated may be adopted. As each of the above informing processing, not only displaying on the display section 60, but also outputting a synthetic voice from a voice output part not shown may be adopted.

The display section 60 consists of a display unit such as a liquid crystal display or an organic EL display. The communication section 70 has a radio communication function for conducting data communications or telephonic communications with the outside through a communication network of every kind such as a mobile phone net or the Internet. The operating section 80 consists of an input unit such as a touch panel or operation buttons.

The passenger management apparatus 1 may also consist of a portable terminal device such as a tablet terminal having a camera function, a radio communication function and a comparatively large display part. Or the passenger management apparatus 1 may be constructed by a system using multiple portable terminal devices. Or the getting-on passenger camera 10 and getting-off passenger camera 20, and the other components including the storage section 40 and microcomputer 50, may be separately constructed so as to exchange information with each other through communications.

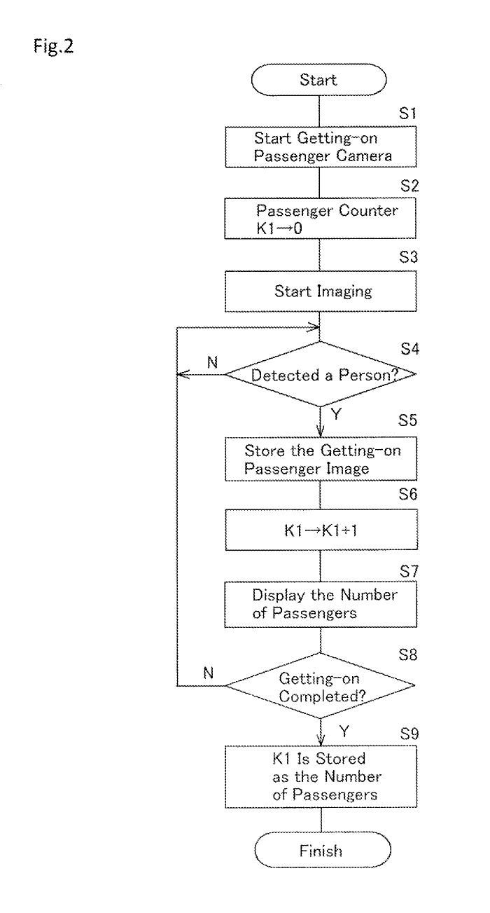

FIG. 2 is a flowchart showing processing operations conducted by the microcomputer 50 in the passenger management apparatus 1 according to the embodiment (1). These processing operations are conducted, for example, when passengers scheduled to get on (tour participants) are allowed to get on a bus at the point of departure.

In step S1, on the basis of a prescribed start signal, the getting-on passenger camera 10 is started, and a passenger counter K₁ is set to be zero (cleared) (step S2). And thereafter, imaging processing is started (step S3). The prescribed start signal includes, for example, an operation signal by a crew member (a manager of this apparatus), or a prescribed operation signal (e.g., an operation signal for door opening) received from the bus side. As the imaging processing, besides taking moving images, still images may be taken intermittently. Or only when a person is detected, imaging processing may be conducted.

In step S4, whether a face of a person was detected in the picked-up image is judged. When it is judged that a face of a person was detected therein, the operation goes to step S5, wherein the image including the face thereof is associated with its picked-up time and stored in the getting-on passenger image storing part 41.

As a method for detecting a face of a person in an image, for example, a method wherein an area (a rectangular area) matching a person's face is detected in a picked-up image, the positions of feature points such as eyes, a nose and the ends of a mouth are extracted from the face image area, and the person is individually detected on the basis of these positions of feature points, is adopted. Or other face detecting techniques may be applied. In the getting-on passenger image storing part 41, information of the image including the detected face of the person (including information such as the feature point positions on the face) is associated with the image's picked-up time and stored.

In step S6, one is added to the passenger counter K₁, and in step S7, informing processing of displaying the number of passengers on the display section 60 is conducted. On the display section 60, for example, a sentence “The current number of passengers on board is ◯◯.” is displayed. The number of passengers may be also informed by a voice (a synthetic voice) from a voice output part (not shown).

In step S8, on the basis of a prescribed condition, whether getting-on of all of the passengers scheduled to get on was completed is judged. The prescribed condition includes, for example, a case where the passenger counter K₁ reached the predetermined number or the maximum number of passengers, a case where a getting-on completion operation was inputted by a crew member, or a case where an input of an entrance door closing operation was received from the bus side. When it is judged that getting-on of all of the passengers scheduled to get on has not been completed yet in step S8, the operation returns to step S4. On the other hand, when it is judged that getting-on of all of the passengers scheduled to get on was completed, the operation goes to step S9, wherein the reading of the counter K₁ is stored as the number of passengers. Then, the processing is finished.

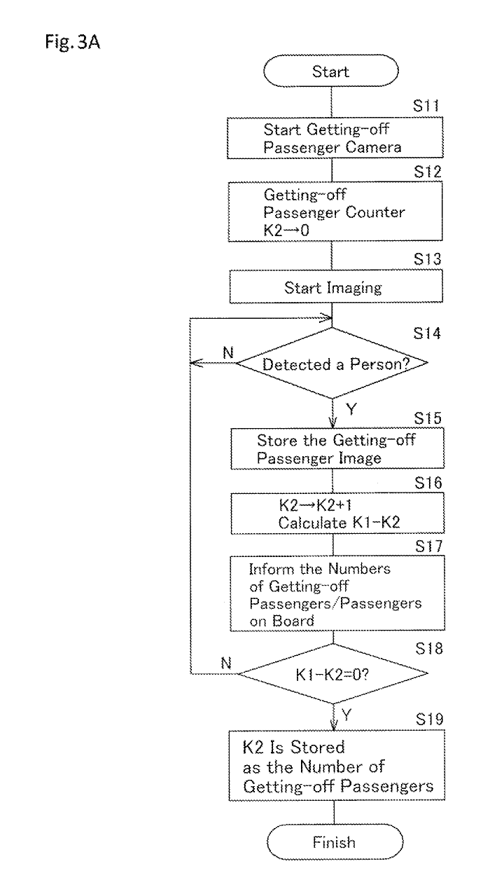

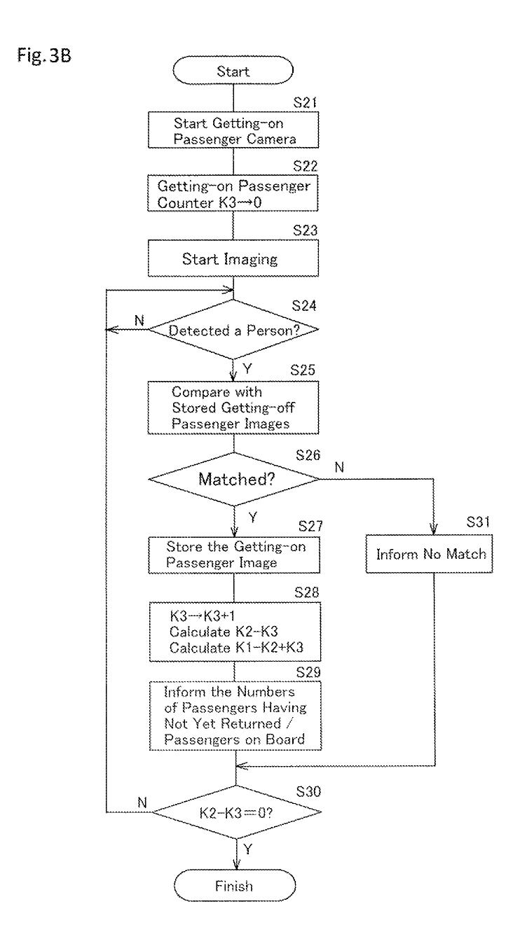

FIGS. 3A and 3B are flowcharts showing processing operations conducted by the microcomputer 50 in the passenger management apparatus 1 according to the embodiment (1). FIG. 3A shows the processing operations conducted, for example, when a passenger gets off the bus at a rest spot or a sightseeing spot, while FIG. 3B shows the processing operations conducted, for example, when the passenger who got off at the rest spot or the sightseeing spot gets on the bus again.

In step S11 shown in FIG. 3A, on the basis of a prescribed start signal, the getting-off passenger camera 20 is started, and a getting-off passenger counter K₂ is set to be zero (cleared) (step S12). And thereafter, imaging processing is started (step S13). The prescribed start signal includes, for example, an operation signal by a crew member, or a prescribed operation signal (e.g., an operation signal for door opening) received from the bus side. As the imaging processing, besides taking moving images, still images may be taken intermittently. Or only when a person is detected, imaging processing may be conducted.

In step S14, whether a face of a person getting off was detected in the picked-up image is judged. When it is judged that a face of a person was detected therein, the operation goes to step S15, wherein the image including the face thereof is associated with its picked-up time and stored in the getting-off passenger image storing part 42.

As a method for detecting a face of a person in an image, the same method as the method for detecting a person by the getting-on passenger camera 10 is adopted. In the getting-off passenger image storing part 42, information of the image including the detected face of the person (including information such as the feature point positions on the face) is associated with the image's picked-up time and stored.

In step S16, one is added to the getting-off passenger counter K₂, and the reading of K₂ is deducted from the reading of K₁. Thereafter, in step S17, informing processing of displaying the number of getting-off passengers (the reading of K₂) and the number of passengers staying in the bus (the value of K₁−K₂) on the display section 60 is conducted.

In step S18, whether the number of passengers staying in the bus (K₁−K₂) decreased to zero is judged. When it is judged that the number of passengers staying in the bus is not zero, the operation returns to step S14. On the other hand, when it is judged that the number of passengers staying in the bus is zero in step S18, the reading of the getting-off passenger counter K₂ is stored as the number of getting-off passengers (step S19). Then, the processing is finished.

In step S21 shown in FIG. 3B, on the basis of a prescribed start signal, the getting-on passenger camera 10 is started, and a getting-on passenger counter K₃ is set to be zero (cleared) (step S22). And thereafter, imaging processing is started (step S23). The prescribed start signal includes, for example, an operation signal by a crew member, or a prescribed operation signal (e.g., an operation signal for door opening) received from the bus side.

In step S24, whether a face of a person getting on was detected is judged. When it is judged that a face of a person was detected, the operation goes to step S25. In step S25, processing of comparing the image including the face of the person concerned with a getting-off passenger image stored in the getting-off passenger image storing part 42 (image recognition processing) is conducted. In the face comparison processing, the image including the face thereof and each of the getting-off passenger images stored in the getting-off passenger image storing part 42 are compared. To the comparison, for example, face identification processing wherein the positions, sizes and heights of feature points of a face, such as eyes, a nose and a mouth, and the outline of the face extracted from each image are compared, and based on the degree of similarity of these feature points, whether they are the same person is judged, may be applied. Other face identification techniques may be also applied.

In step S26, whether the image of the face thereof matched one of the face images of the getting-off passengers stored in the getting-off passenger image storing part 42 is judged. When it is judged that there is a match, the operation goes to step S27. In step S27, the image including the face thereof is associated with its picked-up time and stored in the getting-on passenger image storing part 41.

In step S28, one is added to the getting-on passenger counter K₃, and the number of passengers having not yet returned (K₂−K₃) and the number of passengers on board (K₁−K₂+K₃) are calculated. Then, the operation goes to step S29, wherein informing processing of displaying the calculated numbers of passengers having not yet returned (K₂−K₃) and passengers on board (K₁−K₂+K₃) on the display section 60 is conducted. In step S30, whether the number of passengers having not yet returned (K₂−K₃) decreased to zero is judged. When it is judged that the number of passengers having not yet returned is not zero (some passengers have not yet returned), the operation returns to step S24. On the other hand, when it is judged that the number of passengers having not yet returned is zero (all of the passengers returned) in step S30, the processing is finished.

On the other hand, when it is judged in step S26 that the image of the face thereof matches none of the face images of the getting-off passengers stored in the getting-off passenger image storing part 42 (there is no match), the operation goes to step S31. In step S31, informing processing of displaying the result of no match on the display section 60 is conducted, and the operation goes to step S30.

By the informing processing conducted in step S31, the crew member can know at once that the person getting on is not a passenger getting on again. As a result, the crew member can soon ask the person getting on if he/she got on a wrong bus. In the case of a tour using multiple buses, processing may be conducted, wherein the face image of the person concerned is sent to the passenger management apparatuses 1 mounted on the other buses, image comparison processing is conducted in the passenger management apparatus 1 of each bus, and those comparison results are received and informed. When a construction wherein a plurality of passenger management apparatuses 1 are used in cooperation is adopted, it is possible to quickly tell a person who got on a wrong bus which bus he/she should get on.

Using the passenger management apparatus 1 according to the embodiment (1), on the basis of the images of the getting-on passengers with each picked-up time stored in the getting-on passenger image storing part 41, and the images of the getting-off passengers with each picked-up time stored in the getting-off passenger image storing part 42, the number of persons in the bus (the number of passengers) can be continuously managed. And by comparing the face images of the passengers who got off after getting-on with the face images of the passengers getting on after getting-off (face identification), the return state of the passengers can be appropriately managed without asking the passengers to hold a device for exclusive use such as an IC tag. In addition, it is possible to prevent a person different from the passengers who got off after getting-on, for example, a suspicious person from getting on, leading to maintaining the safety of passengers.

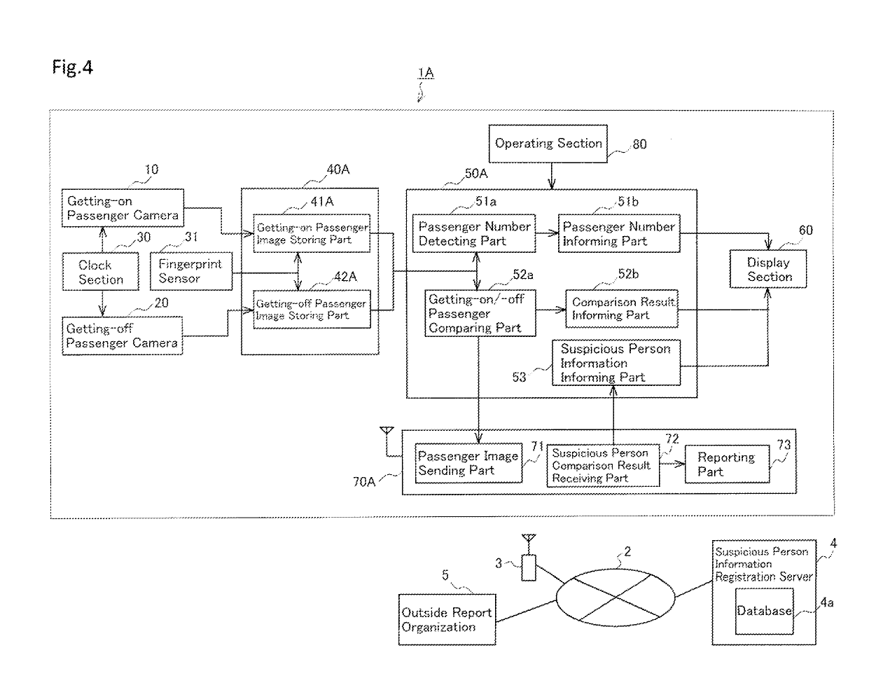

FIG. 4 is a block diagram schematically showing a construction of a passenger management apparatus 1A according to an embodiment (2). The components thereof similar to those of the passenger management apparatus 1 according to the embodiment (1) are given the same reference signs and are not explained here.

The passenger management apparatus 1A according to the embodiment (2) further has a fingerprint sensor 31 for reading fingerprints of passengers getting on/off. It also has a function of making an access to an outside suspicious person information registration server 4 through a communication network 2 when the comparison result of face images (face identification result) shows that there is no match, so as to receive and inform the result of comparison with suspicious person data conducted in the suspicious person information registration server 4.

The passenger management apparatus 1A according to the embodiment (2) comprises a getting-on passenger camera 10, a getting-off passenger camera 20, a clock section 30, the fingerprint sensor 31, a storage section 40A, a microcomputer 50A, a display section 60, a communication section 70A, and an operating section 80.

The fingerprint sensor 31, for example, consists of a semiconductor-type fingerprint sensor, having a function of detecting changes in charge of electrodes which are different depending on the unevenness of a fingerprint, converting these charge quantities to voltages, and further converting those to a fingerprint image, when a finger is put on the sensor. And it has a function of extracting feature points such as a center point of the fingerprint pattern, and branching points, endpoints and deltas of the fingerprint ridge pattern, from the acquired fingerprint image. The fingerprint sensor 31 may be placed at a position where one can easily touch it by finger in getting-on/-off, for example, it is preferably placed near the entrance door or exit door of the bus. It is also acceptable to install a plurality of fingerprint sensors 31.

In the embodiment (2), the fingerprint sensor 31 is adopted as a biometric identification information acquiring means, but the biometric identification information acquiring means is not limited to the fingerprint sensor 31. One or more sensors which can acquire biometric information such as a venous pattern, a retina or a voice (a voiceprint) whereby an individual can be identified may be applied.

The storage section 40A comprises a getting-on passenger image storing part 41A and a getting-off passenger image storing part 42A. In the getting-on passenger image storing part 41A, an image including a face of a passenger getting on picked up by the getting-on passenger camera 10 and fingerprint information (a fingerprint image and feature points) of the passenger getting on acquired by the fingerprint sensor 31, are associated with the image's picked-up time and stored. In the getting-off passenger image storing part 42A, an image including a face of a passenger getting off picked up by the getting-off passenger camera 20 and fingerprint information (a fingerprint image and feature points) of the passenger getting off acquired by the fingerprint sensor 31 are associated with the image's picked-up time and stored.

The microcomputer 50A has functions as a passenger number detecting part 51a for detecting the number of passengers on the basis of the information stored in the getting-on passenger image storing part 41A and the getting-off passenger image storing part 42A, and as a passenger number informing part 51b. In addition, it has functions as a getting-on/-off passenger comparing part 52a for comparing a passenger who got off after getting-on with a passenger getting on after the getting-off (image recognition processing) on the basis of the information stored in the getting-on passenger image storing part 41A and the getting-off passenger image storing part 42A, and as a comparison result informing part 52b. It also has a function as a suspicious person information informing part 53 for informing by displaying suspicious person information received by a below-described suspicious person comparison result receiving part 72 on the display section 60. In the microcomputer 50A, programs and data for implementing these functions are stored. Each of the above informing processing may be conducted not only by displaying on the display section 60 but also by outputting a synthetic voice from a voice output part not shown.

The communication section 70A comprises functions as a passenger image sending part 71, the suspicious person comparison result receiving part 72 and a reporting part 73. The passenger image sending part 71 has a function whereby, when the comparison result by the getting-on/-off passenger comparing part 52a shows that there is no match, the image including the face of the person concerned is sent to the suspicious person information registration server 4 through a radio base station 3 and the communication network 2. The suspicious person comparison result receiving part 72 has a function of receiving the suspicious person comparison result sent from the suspicious person information registration server 4. The reporting part 73 has a function of reporting to an outside organization such as the police, the security police or a security company when the comparison result shows that the person is a suspicious person.

The passenger management apparatus 1A may also consist of a portable terminal device such as a tablet terminal, or the passenger management apparatus 1A may be constructed by a system using a plurality of portable terminal devices. Or the getting-on passenger camera 10, getting-off passenger camera 20 and fingerprint sensor 31, and the other components including the storage section 40A and microcomputer 50A, may be separately constructed so as to exchange information with each other through communications.

The suspicious person information registration server 4 consists of a computer having a suspicious person information database 4a, in which suspicious person information including names, face images, physical characteristics, criminal records and the like of suspicious persons (such as criminals) collected by the police, the security police, etc. is registered. When receiving an image from the passenger management apparatus 1A, the suspicious person information registration server 4 compares the image with the images in the suspicious person information database 4a and sends the comparison result to the passenger management apparatus 1A. The comparison result may include, for example, result information of a match or no match, and furthermore, the suspicious person information when the image matched a certain suspicious person.

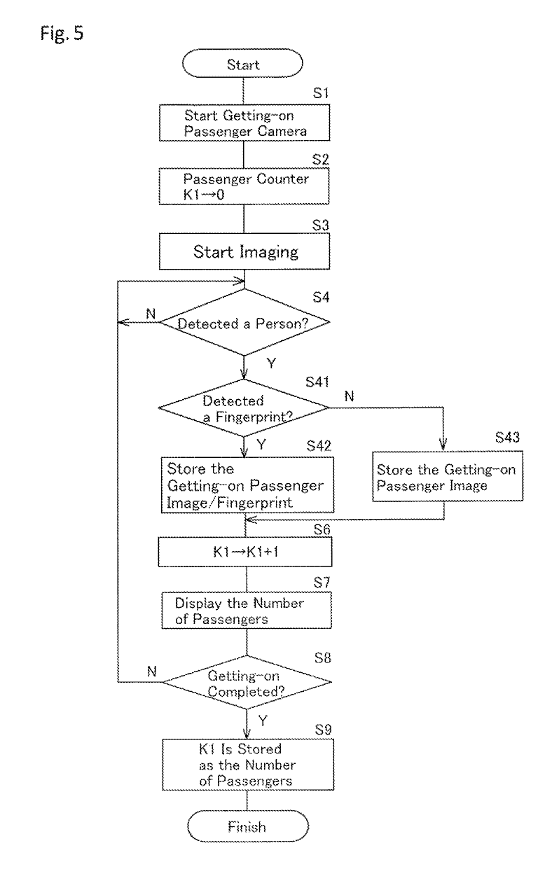

FIG. 5 is a flowchart showing processing operations conducted by the microcomputer 50A in the passenger management apparatus 1A according to the embodiment (2). These processing operations are conducted, for example, when passengers scheduled to get on (tour participants) are allowed to get on a bus at the point of departure and the like. The processing operations similar to those shown in FIG. 2 are given the same reference signs and are not explained here.

In step S1, the getting-on passenger camera 10 is started, and a passenger counter K₁ is set to be zero (step S2). And thereafter, imaging processing is started (step S3). In step S4, whether a face of a person was detected in the picked-up image is judged. When it is judged that a face of a person was detected therein, the operation goes to step S41.

In step S41, whether a fingerprint was detected by the fingerprint sensor 31 is judged. When it is judged that a fingerprint was detected in step S41, the operation goes to step S42. In step S42, the image including the face of the person concerned and fingerprint information are associated with the image's picked-up time and stored in the getting-on passenger image storing part 41A, and thereafter, the operation goes to step S6. On the other hand, when it is judged that no fingerprint is detected in step S41, the operation goes to step S43, wherein the image including the face thereof is associated with its picked-up time and stored in the getting-on passenger image storing part 41A. Thereafter, the operation goes to step S6.

In step S6, one is added to the passenger counter K₁, and thereafter, informing processing of displaying the number of passengers on the display section 60 is conducted (step S7). In step S8, whether getting-on of all of the passengers scheduled to get on was completed is judged. When it is judged that getting-on of all of the passengers scheduled to get on has not been completed, the operation returns to step S4. On the other hand, when it is judged that getting-on of all of the passengers scheduled to get on was completed in step S8, the reading of the passenger counter K₁ is stored as the number of passengers (step S9). Then, the processing is finished.

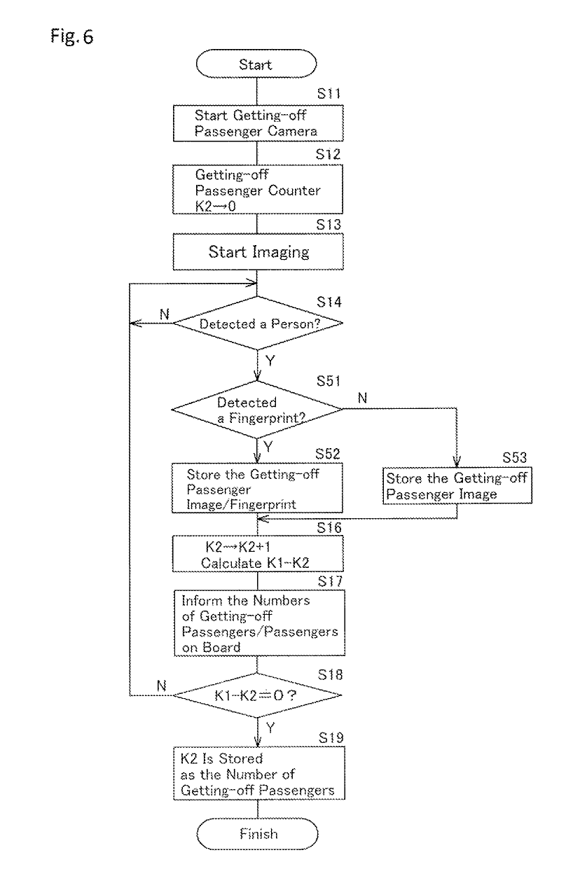

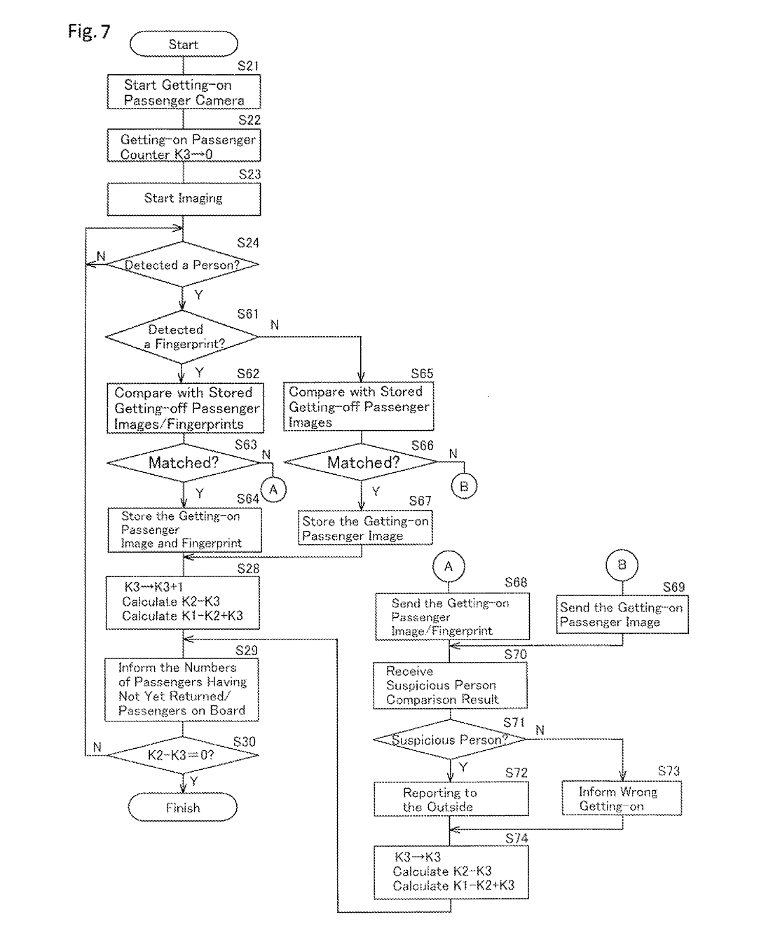

FIGS. 6 and 7 are flowcharts showing processing operations conducted by the microcomputer 50A in the passenger management apparatus 1A according to the embodiment (2). FIG. 6 shows the processing operations conducted, for example, when a passenger gets off the bus at a rest spot or a sightseeing spot, while FIG. 7 shows the processing operations conducted, for example, when the passenger who got off at the rest spot or the sightseeing spot gets on the bus again. The processing operations similar to those shown in FIGS. 3A and 3B are given the same reference signs and are not explained here.

In step S11 shown in FIG. 6, the getting-off passenger camera 20 is started, and a getting-off passenger counter K₂ is set to be zero (step S12). And thereafter, imaging processing is started (step S13). In step S14, whether a face of a person getting off was detected in the picked-up image is judged. When it is judged that a face of a person was detected therein, the operation goes to step S51.

In step S51, whether a fingerprint was detected by the fingerprint sensor 31 is judged. When it is judged that a fingerprint was detected in step S51, the operation goes to step S52. In step S52, the image including the face of the person concerned and fingerprint information are associated with the image's picked-up time and stored in the getting-off passenger image storing part 42A, and thereafter, the operation goes to step S16. On the other hand, when it is judged that no fingerprint is detected in step S51, the operation goes to step S53, wherein the image including the face thereof is associated with its picked-up time and stored in the getting-off passenger image storing part 42A. Thereafter, the operation goes to step S16.

In step S16, one is added to the getting-off passenger counter K₂, and the reading of K₂ is deducted from the reading of K₁. Thereafter, in step S17, informing processing of displaying the number of getting-off passengers (the reading of K₂) and the number of passengers staying in the bus (the value of K₁−K₂) on the display section 60 is conducted.

In step S18, whether the number of passengers staying in the bus (K₁−K₂) decreased to zero is judged. When it is judged that the number of passengers staying in the bus is not zero, the operation returns to step S14. On the other hand, when it is judged that the number of passengers staying in the bus decreased to zero in step S18, the reading of the getting-off passenger counter K₂ is stored as the number of getting-off passengers (step S19). Then, the processing is finished.

In step S21 shown in FIG. 7, the getting-on passenger camera 10 is started, and a getting-on passenger counter K₃ is set to be zero (step S22). And thereafter, imaging processing is started (step S23). In step S24, whether a face of a person getting on was detected is judged. When it is judged that a face of a person was detected, the operation goes to step S61.

In step S61, whether a fingerprint was detected by the fingerprint sensor 31 is judged. When it is judged that a fingerprint was detected in step S61, the operation goes to step S62. In step S62, processing of comparing the image including the face of the person concerned and the fingerprint information with the information stored in the getting-off passenger image storing part 42A (getting-off passenger images and fingerprint information, or getting-off passenger images) (face and fingerprint identification processing, or face identification processing) is conducted.

In the fingerprint identification processing, the fingerprint image of the person concerned and each of the fingerprint information of the getting-off passengers stored in the getting-off passenger image storing part 42A are compared. To the comparison, for example, a method wherein feature points of a fingerprint, such as a center point of the fingerprint pattern, and branching points, endpoints and deltas of the fingerprint ridge pattern, are extracted from each fingerprint image, these feature points are compared, and based on the degree of similarity of these feature points, whether they are the same person is judged, may be applied. Other fingerprint identification techniques may be also applied.

In step S63, whether the face image and fingerprint thereof matched the face image and fingerprint of a getting-off passenger stored in the getting-off passenger image storing part 42A is judged. When it is judged that regarding at least either the face image or the fingerprint, there is a match, the operation goes to step S64. In step S64, the image including the face thereof and fingerprint information thereof are associated with the image's picked-up time and stored in the getting-on passenger image storing part 41A, and then, the operation goes to step S28.

On the other hand, when it is judged that no fingerprint is detected in step S61, the operation goes to step S65, wherein processing of comparing the image including the face thereof with the getting-off passenger images stored in the getting-off passenger image storing part 42A (face identification processing) is conducted. In step S66, whether the face image of the person concerned matched the face image of a getting-off passenger stored in the getting-off passenger image storing part 42A is judged. When it is judged that there is a match, the operation goes to step S67. In step S67, the image including the face thereof is associated with its picked-up time and stored in the getting-on passenger image storing part 41A, and then, the operation goes to step S28. Since the processing operations in steps S28-S30 are similar to those in steps S28-S30 shown in FIG. 3B, they are not explained here.

On the other hand, when it is judged that there is no match in both the face images and fingerprints of the getting-off passengers in step S63, the operation goes to step S68, wherein the image and fingerprint information of the passenger getting on is sent to the suspicious person information registration server 4. Thereafter, the operation goes to step S70.

In step S66, when it is judged that the face image thereof matched none of the face images of the getting-off passengers in step S66, the operation goes to step S69, wherein the image of the passenger getting on is sent to the suspicious person information registration server 4. Thereafter, the operation goes to step S70.

In step S70, the suspicious person comparison result sent from the suspicious person information registration server 4 is received, and thereafter, the operation goes to step S71, wherein whether the suspicious person comparison result shows that the person is a suspicious person (the person matches a certain suspicious person) is judged. When it is judged that the person is a suspicious person, the operation goes to step S72. In step S72, processing of reporting the information that a suspicious person got on to an outside report organization 5 such as the police/the security police or a security company is conducted, and thereafter, the operation goes to step S74. On the other hand, when it is judged that the person is not a suspicious person (there is no match in suspicious persons) in step S71, the operation goes to step S73, wherein informing processing of displaying that the person got on a wrong bus on the display section 60 is conducted. Then, the operation goes to step S74, wherein the getting-on passenger counter K₃ remains as it is, and the number of passengers having not yet returned (K₂−K₃) and the number of passengers staying in the bus (K₁−K₂+K₃) are obtained. Then, the operation goes to step S29.

In the case of a tour using multiple buses, in step S73, processing may be conducted, wherein the face image of the person concerned is sent to the passenger management apparatuses 1A mounted on the other buses, image comparison processing is conducted in the passenger management apparatus 1A of each bus, and those comparison results are received and informed. When such construction is adopted, it is possible to quickly tell a person who got on a wrong bus which bus he/she should get on.

Using the passenger management apparatus 1A according to the above embodiment (2), the same effects as the passenger management apparatus 1 according to the above embodiment (1) can be obtained. Furthermore, using the passenger management apparatus 1A, in the processing of detecting the number of passengers by the passenger number detecting part 51a and comparing getting-on/-off passengers by the getting-on/-off passenger comparing part 52a, the fingerprint information of the getting-on/-off passengers as well as the image information can be used. With the information, the accuracy of detection of the number of passengers or the accuracy of comparison of getting-on/-off passengers when the passengers returned can be further enhanced, resulting in passenger management with high accuracy.

Using the passenger management apparatus 1A, when the comparison result in the above step S62 or S65 shows that there is no match (a person who did not get off is getting on), the image of the person concerned is sent to the suspicious person information registration server 4. And the result of comparison with the suspicious person information registered in the suspicious person information database 4a (face identification result) is received and informed, and in case of the person being a suspicious person, it is reported to the outside report organization 5. Consequently, a crew member can be the first to find wrong getting-on or getting-on of a suspicious person. Particularly in case of a suspicious person, measures for securing the safety of passengers can be taken at once. And reporting to the outside report organization 5 makes it possible to allow policemen or security guards to hurry to the spot and hold the suspicious person at an early stage.

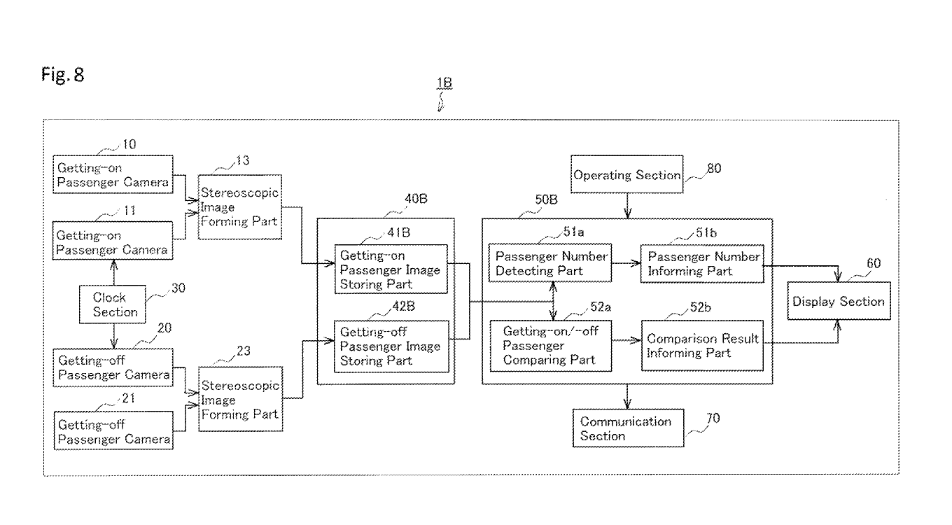

FIG. 8 is a block diagram schematically showing a construction of a passenger management apparatus 1B according to an embodiment (3). The components thereof similar to those of the passenger management apparatus 1 according to the embodiment (1) are given the same reference signs and are not explained here.

The passenger management apparatus 1B according to the embodiment (3) comprises two getting-on passenger cameras 10 and 11, having a function of picking up images of a passenger getting on a bus from different directions (angles) so as to form a stereoscopic image of the passenger getting on using the plurality of images picked up from two directions. It also comprises two getting-off passenger cameras 20 and 21, having a function of picking up images of a passenger getting off the bus from different directions (angles) so as to form a stereoscopic image of the passenger getting off using the plurality of images picked up from two directions. It has a function of comparing a passenger who got off after getting-on with a passenger getting on after getting-off using these stereoscopic images.

The passenger management apparatus 1B according to the embodiment (3) comprises the getting-on passenger cameras 10 and 11, a stereoscopic image forming part 13, the getting-off passenger cameras 20 and 21, a stereoscopic image forming part 23, a clock section 30, a storage section 40B, a microcomputer 50B, a display section 60, a communication section 70, and an operating section 80. In place of the getting-on passenger cameras 10 and 11, or the getting-off passenger cameras 20 and 21, a 3-D camera which forms 3-D images may be adopted, respectively.

The stereoscopic image forming part 13 comprises an image processor which forms a stereoscopic image of a getting-on passenger (particularly a stereoscopic (3-D) image of a face) using a plurality of images picked up from two directions by the getting-on passenger cameras 10 and 11. An image (a stereoscopic image) of the face of the getting-on passenger viewed from all directions (every direction) can be reproduced.

The stereoscopic image forming part 23 comprises an image processor which forms a stereoscopic image of a getting-off passenger (particularly a stereoscopic (3-D) image of a face) using a plurality of images picked up from two directions by the getting-off passenger cameras 20 and 21. An image (a stereoscopic image) of the face of the getting-off passenger viewed from all directions (every direction) can be reproduced.

The storage section 40B comprises a getting-on passenger image storing part 41B and a getting-off passenger image storing part 42B. In the getting-on passenger image storing part 41B, a stereoscopic image including a face of a passenger getting on formed by the stereoscopic image forming part 13 is associated with the images' picked-up time and stored. In the getting-off passenger image storing part 42B, a stereoscopic image including a face of a passenger getting off formed by the stereoscopic image forming part 23 is associated with the images' picked-up time and stored.

The microcomputer 50B has functions as a passenger number detecting part 51a for detecting the number of passengers on the basis of the information stored in the getting-on passenger image storing part 41B and the getting-off passenger image storing part 42B, and as a passenger number informing part 51b. In addition, it has functions as a getting-on/-off passenger comparing part 52a for comparing a passenger who got off after getting-on with a passenger getting on after the getting-off (image recognition processing) on the basis of the information stored in the getting-on passenger image storing part 41B and the getting-off passenger image storing part 42B, and as a comparison result informing part 52b. In the microcomputer 50B, programs and data for implementing these functions are stored. Each of the above informing processing may be conducted not only by displaying on the display section 60 but also by outputting a synthetic voice from a voice output part not shown.

The passenger management apparatus 1B may consist of a portable terminal device such as a tablet terminal. Or the passenger management apparatus 1B may be constructed by a system using multiple portable terminal devices, or one or more portable terminal devices with a 3-D camera mounted thereon. Or the getting-on passenger cameras 10 and 11, stereoscopic image forming part 13, getting-off passenger cameras 20 and 21, stereoscopic image forming part 23 and clock section 30, and the other components including the storage section 40B and microcomputer 50B, may be separately constructed so as to exchange information with each other through communications.

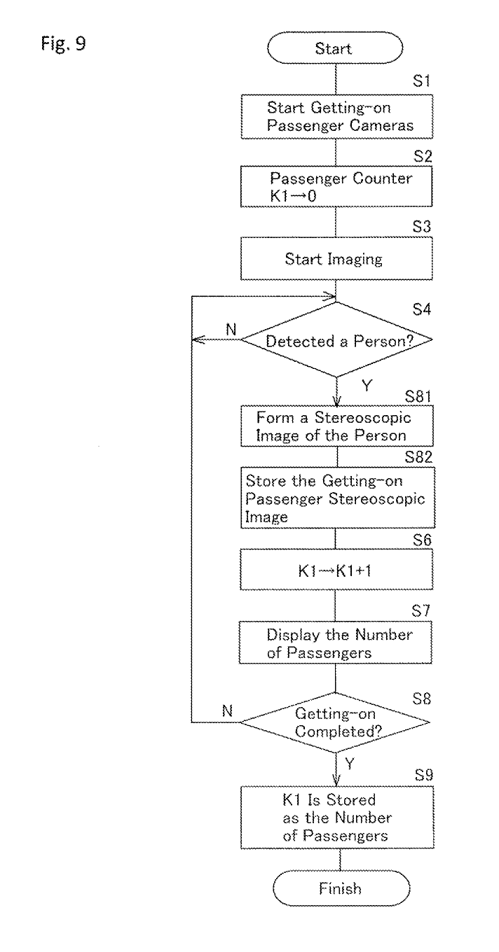

FIG. 9 is a flowchart showing processing operations conducted by the microcomputer 50B in the passenger management apparatus 1B according to the embodiment (3). These processing operations are conducted, for example, when passengers scheduled to get on (who made a reservation) are allowed to get on a bus at the point of departure and the like. The processing operations similar to those shown in FIG. 2 are given the same reference signs and are not explained here.

In step S1, the getting-on passenger cameras 10 and 11 are started, and a passenger counter K₁ is set to be zero (step S2). And thereafter, imaging processing is started (step S3). In step S4, whether a face of a person was detected in the picked-up images is judged. When it is judged that a face of a person was detected therein, the operation goes to step S81.

In step S81, using the plurality of images picked up from two directions by the getting-on passenger cameras 10 and 11, a stereoscopic image of the passenger getting on, for example, a stereoscopic image of the face of the getting-on passenger is formed. In step S82, the formed stereoscopic image including the face of the getting-on passenger is associated with the images' picked-up time and stored in the getting-on passenger image storing part 41B, and thereafter, the operation goes to step S6. Since the processing operations in steps S6-S9 are similar to those in steps S6-S9 shown in FIG. 2, they are not explained here.

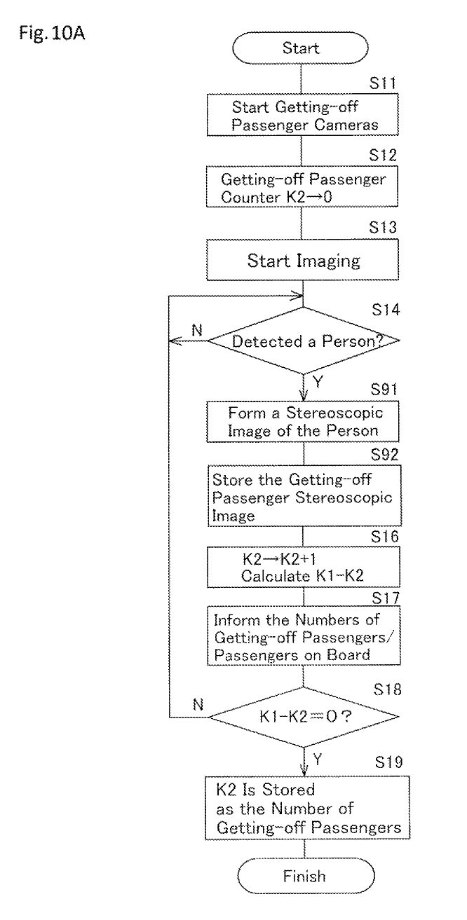

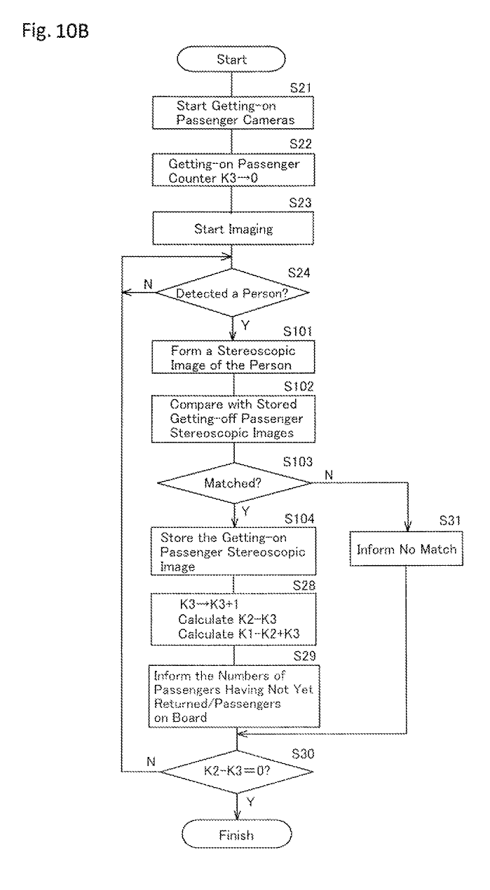

FIGS. 10A and 10B are flowcharts showing processing operations conducted by the microcomputer 50B in the passenger management apparatus 1B according to the embodiment (3). FIG. 10A shows the processing operations conducted, for example, when a passenger gets off the bus at a rest spot or a sightseeing spot, while FIG. 10B shows the processing operations conducted, for example, when the passenger who got off at the rest spot or the sightseeing spot gets on the bus again. The processing operations similar to those shown in FIGS. 3A and 3B are given the same reference signs and are not explained here.

In step S11 shown in FIG. 10A, the getting-off passenger cameras 20 and 21 are started, and a getting-off passenger counter K₂ is set to be zero (step S12). And thereafter, imaging processing is started (step S13). In step S14, whether a face of a person getting off was detected in the picked-up images is judged. When it is judged that a face of a person was detected therein, the operation goes to step S91.

In step S91, using the plurality of images picked up from two directions by the getting-off passenger cameras 20 and 21, a stereoscopic image of the passenger getting off, for example, a stereoscopic image of the face of the getting-off passenger is formed. In step S92, the formed stereoscopic image including the face of the getting-off passenger is associated with the images' picked-up time and stored in the getting-off passenger image storing part 42B, and thereafter, the operation goes to step S16. Since the processing operations in steps S16-S19 are similar to those in steps S16-S19 shown in FIG. 3A, they are not explained here.

In step S21 shown in FIG. 10B, the getting-on passenger cameras 10 and 11 are started, and a getting-on passenger counter K₃ is set to be zero (step S22). And thereafter, imaging processing is started (step S23). In step S24, whether a face of a person getting on was detected is judged. When it is judged that a face of a person was detected, the operation goes to step S101.

In step S101, using the plurality of images picked up from two directions by the getting-on passenger cameras 10 and 11, a stereoscopic image of the passenger getting on, for example, a stereoscopic image of the face of the getting-on passenger is formed. In step S102, processing of comparing the stereoscopic image including the face of the getting-on person concerned with the stereoscopic face image of the getting-off passenger stored in the getting-off passenger image storing part 42B (identification processing using stereoscopic face images) is conducted.

In the stereoscopic face image comparing processing, for example, the stereoscopic face image of the getting-on person concerned is compared with each of the stereoscopic face images of the getting-off passengers stored in the getting-off passenger image storing part 42B. To the comparison, for example, face identification processing may be applied, wherein the features of the face, for example, the stereoscopic feature points such as the positions, sizes and heights of feature points of a face, such as eyes, a nose and a mouth, and the outline of the face, are extracted from each stereoscopic image, these feature points are compared, and based on the degree of similarity of these feature points, whether they are the same person is judged. Other face identification techniques may be also applied.

In step S103, whether the stereoscopic face image of the person concerned matched a stereoscopic face image of a getting-off passenger stored in the getting-off passenger image storing part 42B is judged. When it is judged that there is a match, the operation goes to step S104, wherein the stereoscopic image including the face of the person concerned is associated with the images' picked-up time and stored in the getting-on passenger image storing part 41B. Then, the operation goes to step S28. Since the processing operations in steps S28-S31 are similar to those in steps S28-S31 shown in FIG. 3B, they are not explained here.

Using the passenger management apparatus 1B according to the above embodiment (3), the same effects as the passenger management apparatus 1 according to the above embodiment (1) can be obtained. Furthermore, using the passenger management apparatus 1B, stereoscopic images (3-D images) of the faces of getting-on/-off passengers are formed, and by the getting-on/-off passenger comparing part 52a, the stereoscopic face images of the passengers who got off after getting-on are compared with the stereoscopic face images of the passengers getting on after getting-off Consequently, compared to the comparison between plane images, the accuracy of comparison (accuracy of face identification) can be improved to a probability of approximately 100%.

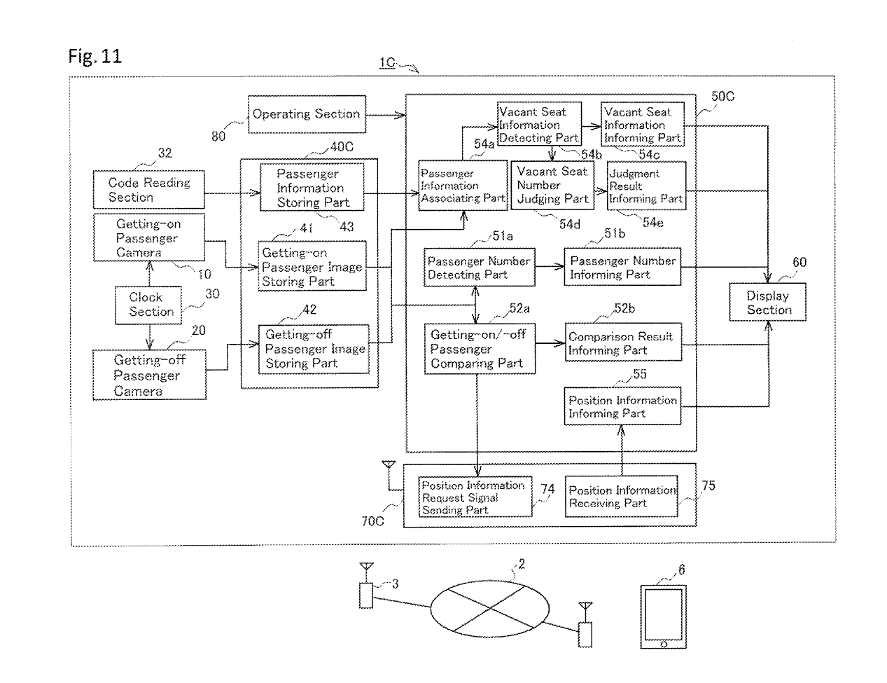

FIG. 11 is a block diagram schematically showing a construction of a passenger management apparatus 1C according to an embodiment (4). The components thereof similar to those of the passenger management apparatus 1 according to the embodiment (1) are given the same reference signs and are not explained here.

The passenger management apparatus 1C according to the embodiment (4) has a code reading section 32 for reading a code (a bar code, a two-dimensional code, etc.) printed on a passenger ticket. And it has functions of storing passenger information (the name, seat position, contact information of a portable terminal device of the passenger) recorded in the code in a passenger information storing part 43, and associating the passenger information with information stored in a getting-on passenger image storing part 41 and a getting-off passenger image storing part 42 so as to detect and inform vacant seat information of the bus. It also has functions of sending a position information request signal to a portable terminal device 6 of a passenger who did not return by the expected time (the expected time of departure), as a result of comparison by a getting-on/-off passenger comparing part 52a, and informing the position information received from the portable terminal device 6 thereof. The portable terminal device 6 includes a mobile phone or a smart phone.

The passenger management apparatus 1C according to the embodiment (4) comprises a getting-on passenger camera 10, a getting-off passenger camera 20, a clock section 30, the code reading section 32, a storage section 40C, a microcomputer 50C, a display section 60, a communication section 70C, and an operating section 80.

The code reading section 32 is a device for optically reading a code (a bar code, a two-dimensional code, etc.) printed on a passenger ticket. Besides a reading device for exclusive use, a portable terminal device with a reading function (an application program for reading) mounted thereon may be used. The code reading section 32 may be placed at a position where a passenger getting on easily hold a passenger ticket thereover. Or a crew member may hold the code reading section 32 over the passenger ticket.

The storage section 40C comprises the getting-on passenger image storing part 41 and the getting-off passenger image storing part 42, and further the passenger information storing part 43 for storing the passenger information (such as the name and seat position of the passenger) recorded in the code read by the code reading section 32.

The microcomputer 50C has functions as a passenger number detecting part 51a, a passenger number informing part 51b, the getting-on/-off passenger comparing part 52a and a comparison result informing part 52b. Furthermore, it has functions as a passenger information associating part 54a, a vacant seat information detecting part 54b, a vacant seat information informing part 54c, a vacant seat number judging part 54d, a judgment result informing part 54e and a position information informing part 55. In the microcomputer 50C, programs and data for implementing these functions are stored.

The passenger information associating part 54a associates the information stored in the getting-on passenger image storing part 41 and the getting-off passenger image storing part 42 with the information (including the name and seat position of the passenger) stored in the passenger information storing part 43. The vacant seat information detecting part 54b detects the positions and number of vacant seats of the bus based on the information associated by the passenger information associating part 54a. The vacant seat information informing part 54c conducts informing processing of displaying the positions and/or number of vacant seats detected by the vacant seat information detecting part 54b on the display section 60. The vacant seat number judging part 54d judges whether the number of vacant seats detected by the vacant seat information detecting part 54b is correct in relation to the number of passengers detected by the passenger number detecting part 51a. The judgment result informing part 54e conducts informing processing of displaying the judgment result by the vacant seat number judging part 54d on the display section 60. And the position information informing part 55 conducts informing processing of displaying the position information received through a communication network 2 from the portable terminal device 6 held by a passenger on the display section 60. Each of the above informing processing may be conducted not only by displaying on the display section 60 but also by outputting a synthetic voice from a voice output section not shown.

The communication section 70C has functions as a position information request signal sending part 74 and a position information receiving part 75. The position information request signal sending part 74 has a function of sending a position information request signal to the portable terminal device 6 of a passenger who did not return by the expected time (the expected time of departure), as a result of comparison by the getting-on/-off passenger comparing part 52a. The position information receiving part 75 has a function of receiving the position information sent from the portable terminal device 6 thereof.

The passenger management apparatus 1C may also consist of, for example, a portable terminal device such as a tablet terminal with a camera section, a code reading section (application) and a radio communication section mounted thereon. Or the passenger management apparatus 1C may be constructed by a system using multiple portable terminal devices. Or the getting-on passenger camera 10, getting-off passenger camera 20, clock section 30 and code reading section 32, and the other components including the storage section 40C and microcomputer 50C may be separately constructed so as to exchange information with each other through communications.

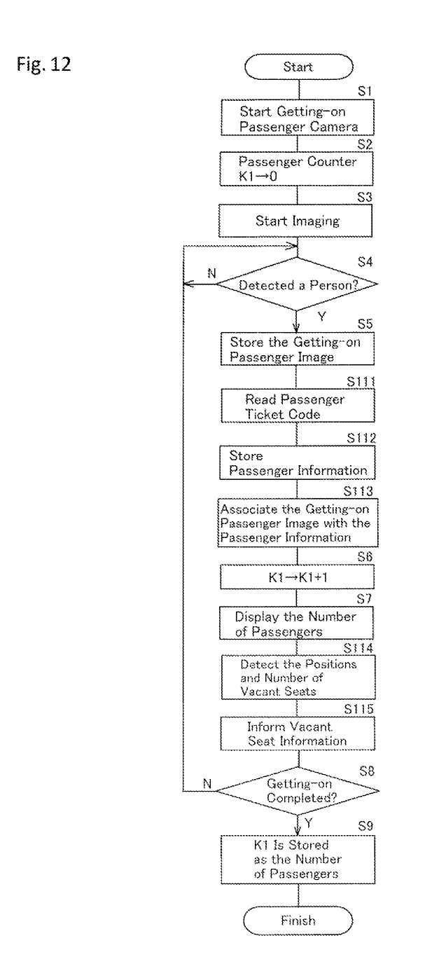

FIG. 12 is a flowchart showing processing operations conducted by the microcomputer 50C in the passenger management apparatus 1C according to the embodiment (4). These processing operations are conducted, for example, when passengers scheduled to get on (tour participants) are allowed to get on a bus at the point of departure and the like. The processing operations similar to those shown in FIG. 2 are given the same reference signs and are not explained here.

In step S1, the getting-on passenger camera 10 is started, and a passenger counter K₁ is set to be zero (step S2). And thereafter, imaging processing is started (step S3). In step S4, whether a face of a person was detected in the picked-up image is judged. When it is judged that a face of a person was detected therein, the operation goes to step S5, wherein the image including the face of the person concerned is associated with its picked-up time and stored in the getting-on passenger image storing part 41. Then, the operation goes to step S111.

In step S111, the code reading section 32 reads a code on a passenger ticket, and in step S112, passenger information (including the name and seat position thereof) recorded in the read code is stored in the passenger information storing part 43. Then, the operation goes to step S113.

In step S113, the information stored in the getting-on passenger image storing part 41 is associated with the passenger information stored in the passenger information storing part 43. For example, processing of associating the getting-on passenger image with the name and seat position thereof using an association code (data) is conducted, and thereafter, the operation goes to step S6. By this processing, the picked-up image and the name and seat position are associated.

In step S6, one is added to the passenger counter K₁. In step S7, informing processing of displaying the number of passengers on the display section 60 is conducted, and thereafter, the operation goes to step S114. In step S114, on the basis of the information associated in step S113, the positions and number of vacant seats of the bus are detected, and then, the operation goes to step S115, wherein informing processing of displaying the detected positions and/or number of vacant seats on the display section 60 is conducted. Then, the operation goes to step S8.

In step S8, whether getting-on of all of the passengers scheduled to get on was completed is judged. When it is judged that getting-on of the passengers has not been completed, the operation returns to step S4. On the other hand, when it is judged that getting-on of all of the passengers was completed, the operation goes to step S9, wherein the reading of the passenger counter K₁ is stored as the number of passengers, and then, the processing is finished.

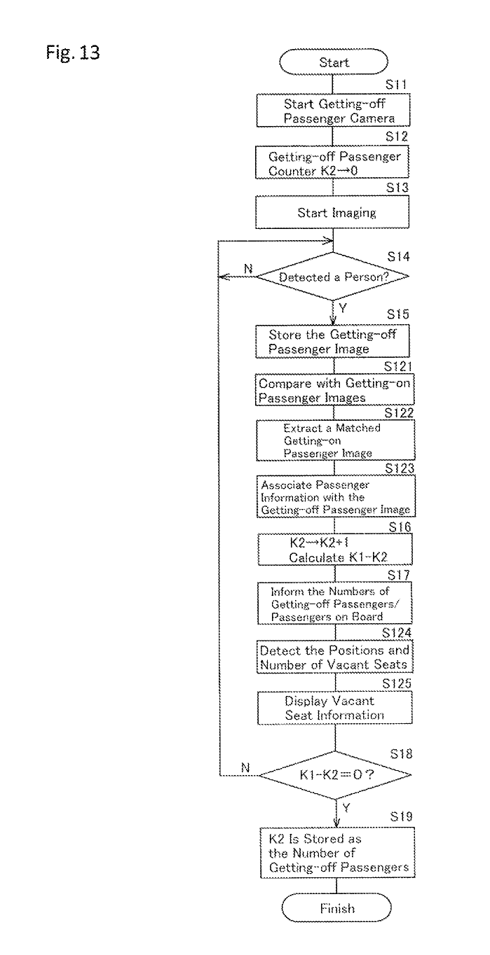

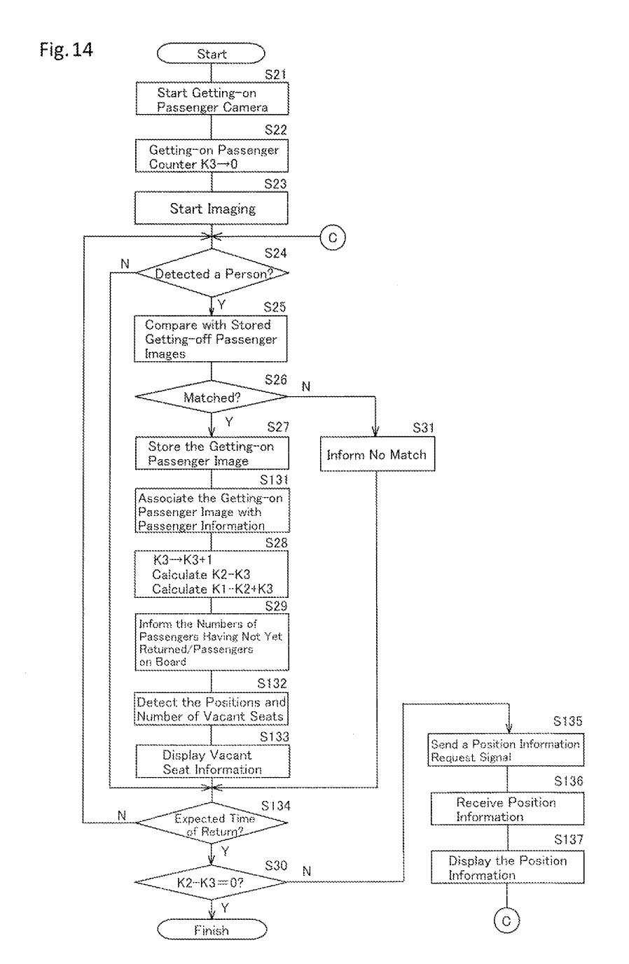

FIGS. 13 and 14 are flowcharts showing processing operations conducted by the microcomputer 50C in the passenger management apparatus 1C according to the embodiment (4). FIG. 13 shows the processing operations conducted, for example, when a passenger gets off the bus at a rest spot or a sightseeing spot, while FIG. 14 shows the processing operations conducted, for example, when the passenger who got off at the rest spot or the sightseeing spot gets on the bus again. The processing operations similar to those shown in FIGS. 3A and 3B are given the same reference signs and are not explained here.

In step S11 shown in FIG. 13, the getting-off passenger camera 20 is started, and a getting-off passenger counter K₂ is set to be zero (step S12). And thereafter, imaging processing is started (step S13). In step S14, whether a face of a person getting off was detected in the picked-up image is judged. When it is judged that a face of a person was detected therein, the operation goes to step S15. In step S15, the image including the face thereof is associated with its picked-up time and stored in the getting-off passenger image storing part 42, and then, the operation goes to step S121.

In step S121, the picked-up getting-off passenger image is compared with the getting-on passenger images stored in the getting-on passenger image storing part 41 (face identification processing), and in step S122, a getting-on passenger image matching the getting-off passenger image is extracted. In step S123, the passenger information associated with the extracted getting-on passenger image and the getting-off passenger image are associated, and thereafter, the operation goes to step S16.

In step S16, one is added to the getting-off passenger counter K₂, and the reading of K₂ is deducted from the reading of K₁. In step S17, informing processing of displaying the number of getting-off passengers (the reading of K₂) and the number of passengers staying in the bus (the value of K₁−K₂) on the display section 60 is conducted, and then, the operation goes to step S124.

In step S124, on the basis of the information associated in step S123, the positions and number of vacant seats of the bus are detected, and thereafter, the operation goes to step S125. In step S125, informing processing of displaying the detected positions and/or number of vacant seats on the display section 60 is conducted, and then, the operation goes to step S18.

In step S18, whether the number of passengers staying in the bus (K₁−K₂) decreased to zero is judged. When it is judged that the number of passengers staying in the bus (K₁−K₂) is not zero, the operation returns to step S14. On the other hand, when it is judged that the number of passengers staying in the bus decreased to zero in step S18, the reading of the getting-off passenger counter K₂ is stored as the number of getting-off passengers (step S19). Then, the processing is finished.

Since the processing operations in steps S21-S27 shown in FIG. 14 are similar to those in steps S21-S27 shown in FIG. 3B, they are not explained here.

In step S27, the image including the face of the person concerned is associated with its picked-up time and stored in the getting-on passenger image storing part 41, and thereafter, the operation goes to step S131. In step S131, the passenger information associated with the getting-off passenger image which matched in the processing in step S25 and the image (getting-on passenger image) including the face of the person concerned are associated, and then, the operation goes to step S28.

In step S28, one is added to the getting-on passenger counter K₃, and the number of passengers having not yet returned (K₂−K₃) and the number of passengers staying in the bus (K₁−K₂+K₃) are calculated. In step S29, informing processing of displaying the number of passengers having not yet returned (K₂−K₃) and the number of passengers staying in the bus (K₁−K₂+K₃) on the display section 60 is conducted, and then, the operation goes to step S132.

In step S132, on the basis of the information associated in step S131, etc., the positions and number of vacant seats of the bus are detected, and thereafter, the operation goes to step S133. In step S133, informing processing of displaying the detected positions and/or number of vacant seats on the display section 60 is conducted, and then, the operation goes to step S134, wherein whether it became the expected time of return (expected time of departure) is judged. When it is judged that the expected time of return has not come, the operation returns to step S24. On the other hand, when it is judged that it became the expected time of return, the operation goes to step S30. In step S30, whether the number of passengers having not yet returned (K₂−K₃) decreased to zero is judged.

When it is judged that the number of passengers having not yet returned is not zero (some passengers have not yet returned) in step S30, the operation goes to step S135. In step S135, the passenger information of the passenger having not yet returned is extracted based on the vacant seat position, and a position information request signal is sent to the portable terminal device 6 of the passenger having not yet returned, and then, the operation goes to step S136. When the portable terminal device 6 of the passenger having not yet returned receives the position information request signal, it sends the current position information to the passenger management apparatus 1C.

In step S136, the position information sent from the portable terminal device 6 of the passenger having not yet returned is received. In step S137, informing processing of displaying the position information (for example, the position on the map) of the passenger having not yet returned on the display section 60 is conducted, and then the operation returns to step S24.

On the other hand, when it is judged that the number of passengers having not yet returned (K₂−K₃) decreased to zero in step S30, the processing is finished.

Using the passenger management apparatus 1C according to the above embodiment (4), the same effects as the passenger management apparatus 1 according to the above embodiment (1) can be obtained. In addition, using the passenger management apparatus 1C, by the passenger information associating part 54a, the image of the passenger who got on and the image of the passenger who got off are associated (bound) with the information of the name, seat position and telephone number of the passenger. Consequently, not only the number of passengers but also the positions and number of vacant seats of the bus can be managed. Furthermore, since whether the number of vacant seats is correct in relation to the number of passengers is judged and the judgment result is informed, the crew member can check the number of passengers at once, leading to confirmation of omission of detection or double detection of some passenger, when the number of vacant seats is not correct in relation to the number of passengers.

Using the passenger management apparatus 1C, a position information request signal is sent to the portable terminal device 6 of the passenger who did not return by the expected time of return, position information sent from the portable terminal device 6 is received, and the received position information is informed. As a result, the crew member can grasp the position of the passenger who did not return at the expected time. And by receiving the position information of the passenger having not yet returned time by time, the return state of the passenger having not yet returned (for example, a state of coming toward the bus) can be also grasped.

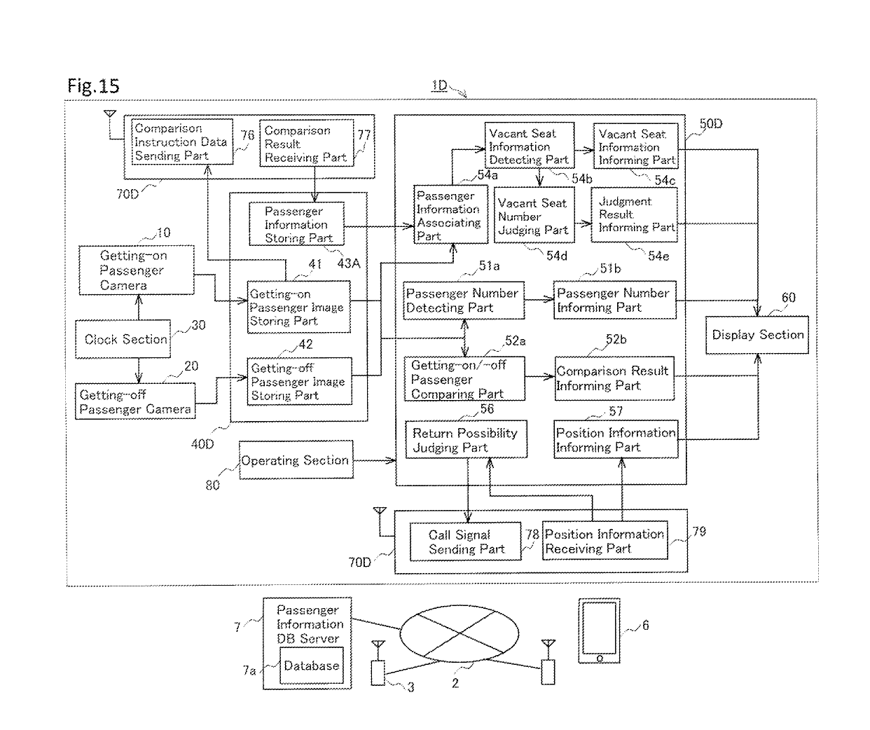

FIG. 15 is a block diagram schematically showing a construction of a passenger management apparatus 1D according to an embodiment (5). The components thereof similar to those of the passenger management apparatus 1C according to the embodiment (4) are given the same reference signs and are not explained here.

In the passenger management apparatus 1C according to the embodiment (4), using the code reading section 32, a code on a passenger ticket is read, and passenger information recorded in the code is stored. On the other hand, in the passenger management apparatus 1D according to the embodiment (5), comparison instruction data including an image picked up by a getting-on passenger camera 10 is sent to a passenger information database server 7, and passenger information received from the passenger information database server 7 is associated with a getting-on passenger image or a getting-off passenger image.

In the passenger management apparatus 1C according to the embodiment (4), position information is requested to a passenger who did not return by the expected time of return. On the other hand, in the passenger management apparatus 1D according to the embodiment (5), position information is periodically received from a portable terminal device 6 of a getting-off passenger, and when it is judged that the passenger cannot return by the expected time of return from the position information, a call signal is sent thereto.

The passenger management apparatus 1D according to the embodiment (5) comprises the getting-on passenger camera 10, a getting-off passenger camera 20, a clock section 30, a storage section 40D, a microcomputer 50D, a display section 60, a communication section 70D, and an operating section 80.

The communication section 70D has a comparison instruction data sending part 76 for sending comparison instruction data including an image picked up by the getting-on passenger camera 10 to the passenger information database server 7, and a comparison result receiving part 77 for receiving the comparison result sent from the passenger information database server 7. The passenger information database server 7, having a database 7a for registering passenger information including the name, seat position, telephone number of the portable terminal device 6, and a face image of the passenger, consists of a server computer. The passenger information database server 7 has a mechanism of, when receiving comparison instruction data including an image from the passenger management apparatus 1D, comparing the received image with face images registered in the database 7a (face identification processing), and sending the comparison result to the passenger management apparatus 1D.

Furthermore, the communication section 70D has a position information receiving part 79 for receiving position information sent from the portable terminal device 6 held by a passenger, and a call signal sending part 78 for sending a call signal to the portable terminal device 6 of a passenger for whom it is difficult to return by the expected time.

The storage section 40D comprises a getting-on passenger image storing part 41 and a getting-off passenger image storing part 42, and further a passenger information storing part 43A for storing the passenger information (such as the name, seat position and telephone number of the portable terminal device of the passenger) received by the comparison result receiving part 77.

The microcomputer 50D has functions as a passenger number detecting part 51a, a passenger number informing part 51b, a getting-on/-off passenger comparing part 52a and a comparison result informing part 52b. Furthermore, it has functions as a passenger information associating part 54a, a vacant seat information detecting part 54b, a vacant seat information informing part 54c, a vacant seat judging part 54d, a judgment result informing part 54e and a position information informing part 55, and functions as a return possibility judging part 56 and a position information informing part 57. In the microcomputer 50D, programs and data for implementing these functions are stored.

The passenger information associating part 54a associates the information stored in the getting-on passenger image storing part 41 and the getting-off passenger image storing part 42, with the passenger information (including the name, seat position and telephone number of the portable terminal device of the passenger) stored in the passenger information storing part 43A. For example, when the comparison result received by the comparison result receiving part 77 shows that there is a match in the face images of passengers registered in the database 7a, the image picked up by the getting-on passenger camera 10 and the passenger information received with the comparison result are associated.

The return possibility judging part 56 judges whether a getting-off passenger can return to the bus by the expected time of return on the basis of the position information sent through a communication network 2 from the portable terminal device 6 held by the getting-off passenger. When it judges that the getting-off passenger cannot return by the expected time of return, it commands sending of a call signal to the portable terminal device 6 of the passenger concerned from the call signal sending part 78. The position information informing part 57 conducts informing processing of displaying the position information received from the portable terminal device 6 of the getting-off passenger on the display section 60. Each of the above informing processing may be conducted not only by displaying on the display section 60 but also by outputting a synthetic voice from a voice output section not shown.

The passenger management apparatus 1D may also consist of, for example, a portable terminal device such as a tablet terminal with a camera section and a radio communication section mounted thereon. Or the passenger management apparatus 1D may be constructed by a system using multiple portable terminal devices. Or the getting-on passenger camera 10, getting-off passenger camera 20 and clock section 30, and the other components including the storage section 40D and microcomputer 50D may be separately constructed so as to exchange information with each other through communications.

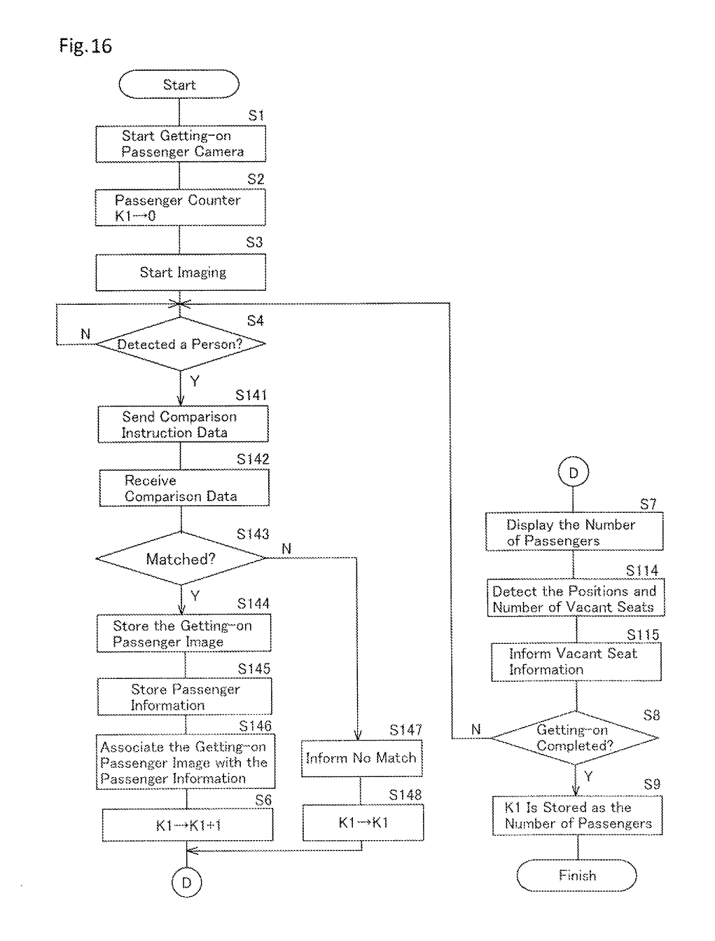

FIG. 16 is a flowchart showing processing operations conducted by the microcomputer 50D in the passenger management apparatus 1D according to the embodiment (5). These processing operations are conducted, for example, when passengers scheduled to get on are allowed to get on a bus at the point of departure and the like. The processing operations similar to those shown in FIG. 12 are given the same reference signs and are not explained here.

In step S1, the getting-on passenger camera 10 is started, and a passenger counter K₁ is set to be zero (step S2). And thereafter, imaging processing is started (step S3). In step S4, whether a face of a person was detected in the picked-up image is judged. When it is judged that a face of a person was detected therein, the operation goes to step S141.

In step S141, comparison instruction data including the picked-up image is sent to the passenger information database server 7. Then, in step S142, the comparison result is received from the passenger information database server 7, and thereafter, the operation goes to step S143. The comparison result includes result information of a match or no match, and in the case of a match, passenger information including the name, seat position, telephone number of the portable terminal device associated with the matched image and registered.

In step S143, whether the comparison result is a match, that is, whether the picked-up image matched an image of a passenger registered in the database 7a is judged. When it is judged that the comparison result shows that there is a match in step S143, the operation goes to step S144, wherein the image including the face of the person is associated with its picked-up time and stored in the getting-on passenger image storing part 41. In step S145, the passenger information included in the comparison result is stored in the passenger information storing part 43A. In step S146, the information stored in the getting-on passenger image storing part 41 and the passenger information stored in the passenger information storing part 43A are associated, and the operation goes to step S6. Since the processing operations in steps S6-S9 are similar to those in steps S6-S9 shown in FIG. 12, they are not explained here.

On the other hand, when it is judged that the comparison result is not a match (no match) in step S143, the operation goes to step S147, wherein informing processing of displaying on the display section 60 that the passenger getting on is not a passenger scheduled to get on is conducted. In step S148, none is added to the passenger counter K₁, and the operation goes to step S7 and thereafter.

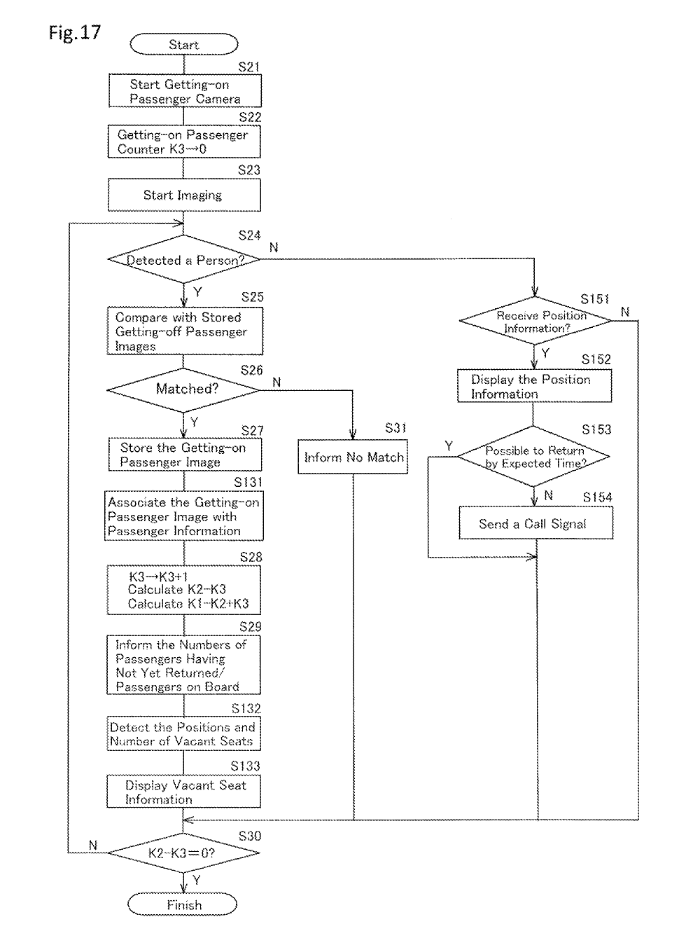

FIG. 17 is a flowchart showing processing operations conducted by the microcomputer 50D in the passenger management apparatus 1D according to the embodiment (5). These processing operations are conducted, for example, when a passenger who got off at a rest spot or a sightseeing spot gets on the bus again. The processing operations similar to those shown in FIG. 14 are given the same reference signs and are not explained here.

Since the processing operations conducted when a passenger gets off a bus at a rest spot or a sightseeing spot are similar to those of the passenger management apparatus 1C according to the embodiment (4) shown in FIG. 13, they are not explained here.

Since the processing operations in steps S21-S133 shown in FIG. 17 are similar to those in steps S21-S133 shown in FIG. 14, they are not explained here.

When it is judged that a face of a person getting on is not detected in step S24, the operation goes to step S151, wherein whether position information sent from the portable terminal device 6 of a getting-off passenger was received is judged. When it is judged that no position information was received in step S151, the operation goes to step S30. On the other hand, when it is judged that position information was received, the operation goes to step S152, wherein informing processing of displaying the received position information on the display section 60 is conducted.

In step S153, on the basis of the position information (the distance between the bus position and the current position of the passenger), whether the passenger can return by the expected time is judged. When it is judged that the passenger can return, the operation goes to step S30. On the other hand, when it is judged that the passenger cannot return in step S153, the operation goes to step S154, wherein a call signal is sent to the portable terminal device 6 of the passenger concerned, and then, the operation goes to step S30. The call signal is a signal for urging the passenger to return, including a calling signal of a telephone, messaging such as e-mail and the like.

In step S30, whether the number of passengers having not yet returned (K₂−K₃) decreased to zero is judged. When it is judged that the number of passengers having not yet returned is not zero (some passengers have not yet returned), the operation returns to step S24. On the other hand, when it is judged that the number of passengers having not yet returned is zero, the processing is finished.

Using the passenger management apparatus 1D according to the embodiment (5), the same effects as the passenger management apparatus 1C according to the embodiment (4) can be obtained. Furthermore, using the passenger management apparatus 1D, the comparison instruction data including an image of a passenger getting on is sent to the passenger information database server 7, the comparison result is received from the passenger information database server 7, and when the comparison result is a match, passenger information received with the comparison result is stored, and the passenger information and the image of the getting-on passenger are associated. Consequently, when a passenger gets on a bus at the spot of departure and the like, the image of the passenger getting on makes it possible to automatically associate the passenger with the passenger information, even if a crew member does not directly check the name of the passenger or a passenger ticket thereof. As a result, it can save the crew member some work, leading to enhanced convenience.

Using the passenger management apparatus 1D, position information is received from a passenger who got off at established intervals, and when it is judged that the passenger cannot return by the expected time from the position information, a call signal is sent to the portable terminal device 6 of the passenger who cannot return. Therefore, the timing of sending a call signal can be controlled depending on the position of the passenger having not yet returned, calling can be conducted with appropriate timing so as to enable the passenger to return by the expected time, and it is possible to prevent the return of the passenger from being long delayed.

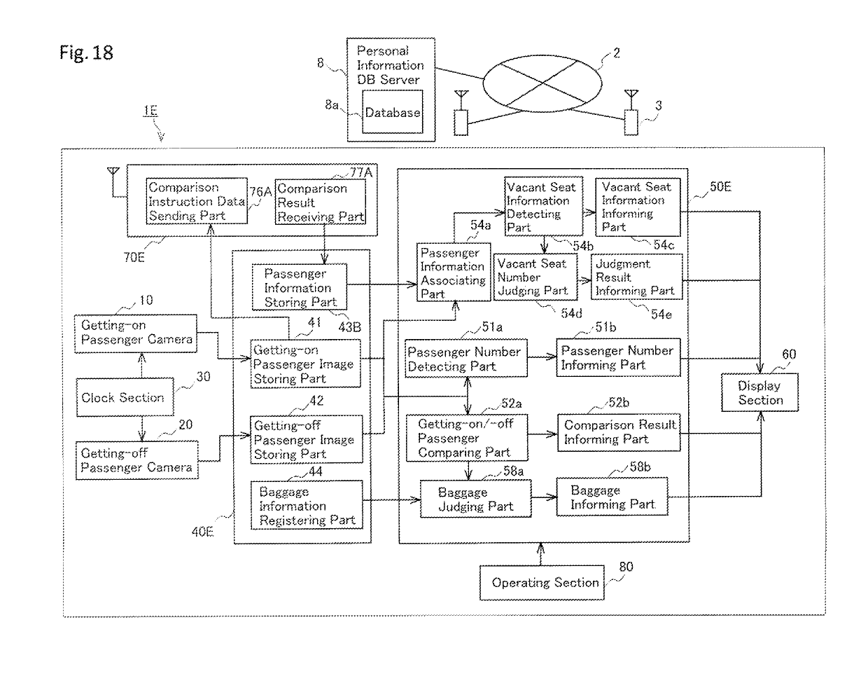

FIG. 18 is a block diagram schematically showing a construction of a passenger management apparatus 1E according to an embodiment (6). The components thereof similar to those of the passenger management apparatus 1C according to the embodiment (4) are given the same reference signs and are not explained here.

In the passenger management apparatus 1C according to the embodiment (4), using the code reading section 32, a code on a passenger ticket is read, and passenger information recorded in the code is stored. On the other hand, in the passenger management apparatus 1E according to the embodiment (6), the names and seat positions of passengers scheduled to get on are previously registered in a passenger information storing part 43B. And comparison instruction data including an image picked up by a getting-on passenger camera 10 is sent to a personal information database server 8, the comparison result is received from the personal information database server 8, and when the same name as personal information (name) included in the comparison result in the case of the comparison result being a match is registered in the passenger information storing part 43B, the passenger information and the getting-on passenger image are associated.

In the passenger management apparatus 1E according to the embodiment (6), information of baggage left by passengers is registered. When there is baggage of a passenger who did not return by the expected time, informing processing of urging checking or removing of the baggage is conducted.

The passenger management apparatus 1E according to the embodiment (6) comprises the getting-on passenger camera 10, a getting-off passenger camera 20, a clock section 30, a storage section 40E, a microcomputer 50E, a display section 60, a communication section 70E, and an operating section 80.

The communication section 70E has a comparison instruction data sending part 76A for sending comparison instruction data including an image picked up by the getting-on passenger camera 10 to the personal information database server 8, and a comparison result receiving part 77A for receiving the result of comparison in the personal information database server 8.

The personal information database server 8, having a database 8a for registering specified personal information including a personal number by which a person can be identified, a name and a face image (e.g., personal information including My Number), consists of a server computer.

The storage section 40E comprises a getting-on passenger image storing part 41 and a getting-off passenger image storing part 42, and further the passenger information storing part 43B for previously storing passenger information including the names and seat positions of passengers scheduled to get on. The personal information (e.g., including at least the name) received by the comparison result receiving part 77A and the passenger information (e.g., the name) stored in the passenger information storing part 43B are compared.

The microcomputer 50E has functions as a passenger number detecting part 51a, a passenger number informing part 51b, a getting-on/-off passenger comparing part 52a and a comparison result informing part 52b. Furthermore, it has functions as a passenger information associating part 54a, a vacant seat information detecting part 54b, a vacant seat information informing part 54c, a vacant seat number judging part 54d and a judgment result informing part 54e, and functions as a baggage judging part 58a and a baggage informing part 58b. In the microcomputer 50E, programs and data for implementing these functions are stored.

The passenger information associating part 54a associates the information stored in the getting-on passenger image storing part 41 and the getting-off passenger image storing part 42, with the information (the name and seat position of the passenger) stored in the passenger information storing part 43B. For example, when the comparison result received by the comparison result receiving part 77A shows that there is a match in the face images of persons registered in the database 8a and that the same name as the personal information (name) included in the comparison result is stored in the passenger information storing part 43B, the information of the passenger concerned (the name and seat position of the passenger) and the image picked up by the getting-on passenger camera 10 are associated. Or when the comparison result received by the comparison result receiving part 77A shows that there is a match in the personal information (face images) registered in the database 8a, the image picked up by the getting-on passenger camera 10 and the personal information (such as the name) received with the comparison result may be associated. By such construction, the image of the getting-on passenger and the name can be automatically associated.

When a passenger who did not return by the expected time is detected as a result of comparison by the getting-on/-off passenger comparing part 52a, the baggage judging part 58a judges whether there is baggage of the passenger having not yet returned on the basis of the information of baggage registered in a baggage information registering part 44. When it is judged that there is baggage of the passenger having not yet returned in the baggage judging part 58a, the baggage informing part 58b conducts informing processing of displaying a description which urges checking or removing of the baggage of the passenger concerned on the display section 60.

The passenger management apparatus 1E may also consist of, for example, a portable terminal device such as a tablet terminal with a camera section and a radio communication section mounted thereon. Or the passenger management apparatus 1E may be constructed by a system using multiple portable terminal devices. Or the getting-on passenger camera 10, getting-off passenger camera 20 and clock section 30, and the other components including the storage section 40E and microcomputer 50E may be separately constructed so as to exchange information with each other through communications.

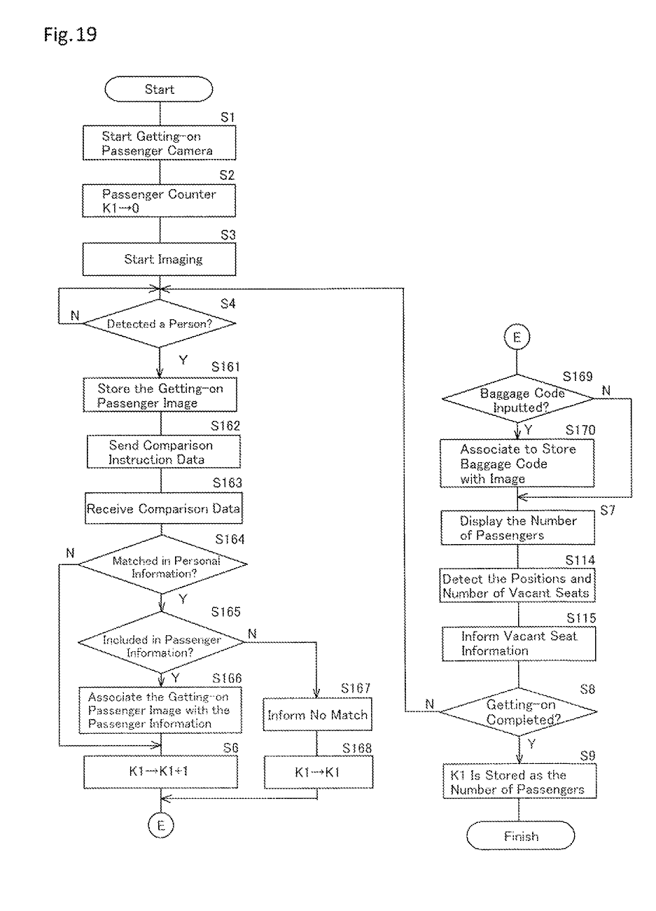

FIG. 19 is a flowchart showing processing operations conducted by the microcomputer 50E in the passenger management apparatus 1E according to the embodiment (6). These processing operations are conducted, for example, when passengers scheduled to get on (who made a reservation) are allowed to get on a bus at the point of departure and the like. The processing operations similar to those shown in FIG. 12 are given the same reference signs and are not explained here.

In step S1, the getting-on passenger camera 10 is started, and a passenger counter K₁ is set to be zero (step S2). And thereafter, imaging processing is started (step S3). In step S4, whether a face of a person was detected in the picked-up image is judged. When it is judged that a face of a person was detected therein, the operation goes to step S161.

In step S161, the picked-up image is associated with its picked-up time and stored in the getting-on passenger image storing part 41, and the operation goes to step S162. In step S162, comparison instruction data including the picked-up image is sent to the personal information database server 8, and thereafter, in step S163, the comparison result is received from the personal information database server 8. Then, the operation goes to step S164. In the comparison result, result information of a match or no match of the picked-up image in the face images included in the database 8a is included. When there is a match, the personal information (at least the name) associated with the matched image (face image) and registered is also received.

In step S164, whether the comparison result shows a match in the personal information, that is, whether the picked-up image matched an image of a person registered in the database 8a is judged. When it is judged that the comparison result shows a match in the personal information, the operation goes to step S165, wherein whether the same information (such as the name) as the personal information (including at least the name) received with the comparison result is included in the passenger information in the passenger information storing part 43B is judged.

When it is judged that the same information as the personal information is included in the passenger information (for example, it matches the name of a passenger scheduled to get on) in step S165, the operation goes to step S166. In step S166, the getting-on passenger image stored in the getting-on passenger image storing part 41 in step S161 and the passenger information judged to match in step S165 are associated, and the operation goes to step S6. In step S6, one is added to the passenger counter K₁, and the operation goes to step S159.

On the other hand, when it is judged that the comparison result shows that there is not a match (no match) in step S164, the operation goes to step S6. Or when it is judged that the same information as the personal information is not included in the passenger information in step S165, the operation goes to step S167. In step S167, informing processing of displaying on the display section 60 that the passenger getting on is not a passenger scheduled to get on is conducted, and without addition to the passenger counter K₁ in step S168, the operation goes to step S169.

In step S169, whether a baggage code attached to baggage which the passenger concerned left was inputted is judged. When it is judged that there was an input of the baggage code, the operation goes to step S170. In step S170, the baggage code and the image of the passenger concerned are associated and stored in the baggage information registering part 44, and the operation goes to step S7. On the other hand, when it is judged that there is no input of baggage code in step S169, the operation goes to step S7. Since the processing operations in steps S7-S9 are similar to those in steps S7-S9 shown in FIG. 12, they are not explained here.

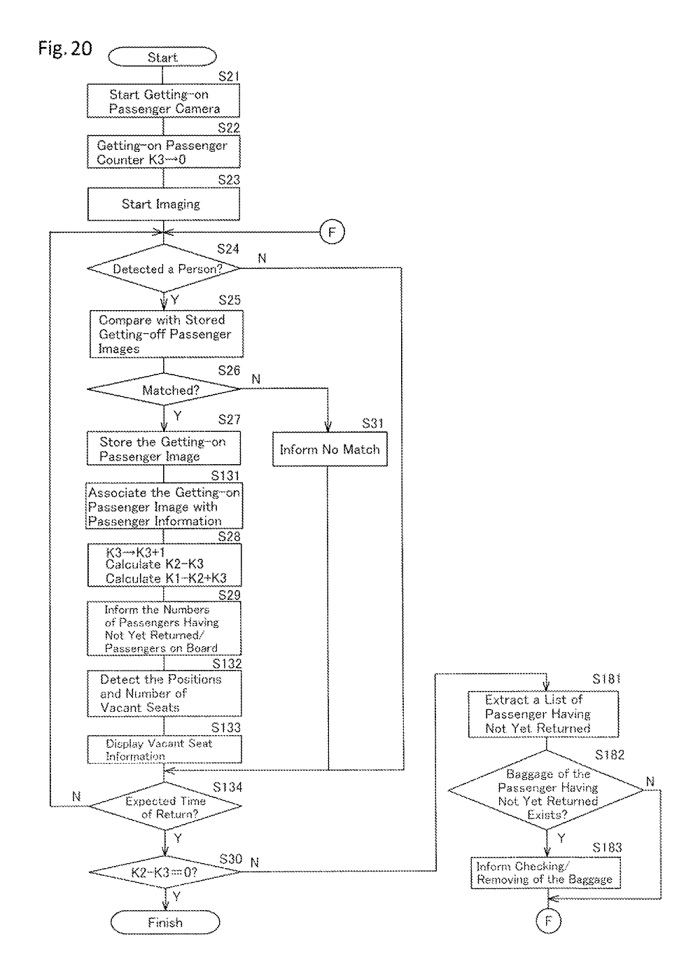

FIG. 20 is a flowchart showing processing operations conducted by the microcomputer 50E in the passenger management apparatus 1E according to the embodiment (6). These processing operations are conducted, for example, when a passenger who got off at a rest spot or a sightseeing spot gets on the bus again. The processing operations similar to those shown in FIG. 14 are given the same reference signs and are not explained here.

Since the processing operations conducted when a passenger is allowed to get off a bus at a rest spot or a sightseeing spot are similar to those of the passenger management apparatus 1C according to the embodiment (4) shown in FIG. 13, they are not explained here.

Since the processing operations in steps S21-S134 shown in FIG. 20 are similar to those in steps S21-S134 shown in FIG. 14, they are not explained here.

When it is judged that it became the expected time of return in step S134, the operation goes to step S30, wherein whether the number of passengers having not yet returned (K₂−K₃) decreased to zero is judged. When it is judged that the number of passengers having not yet returned is not zero (there is (are) a passenger (passengers) having not yet returned), the operation goes to step S181.

In step S181, the list of the passenger having not yet returned is extracted, and in step S182, the passenger information of the passenger having not yet returned and the information stored in the baggage information registering part 44 are compared and whether there is baggage of the passenger having not yet returned is judged.

When it is judged that there is no baggage of the passenger having not yet returned in step S182, the operation returns to step S24. On the other hand, when it is judged that there is baggage of the passenger having not yet returned, the operation goes to step S183, wherein informing processing of displaying on the display section 60 to urge the crew member to check the baggage of the passenger having not yet returned and remove it to the outside of the bus is conducted. Then, the operation returns to step S24. On the other hand, when it is judged that the number of passengers having not yet returned is zero in step S30, the processing is finished.

Using the passenger management apparatus 1E according to the above embodiment (6), the same effects as the passenger management apparatus 1C according to the above embodiment (4) can be obtained. Furthermore, using the passenger management apparatus 1E, the comparison instruction data including an image of a passenger getting on is sent to the personal information database server 8, and the comparison result is received from the personal information database server 8. When the comparison result shows a match, the personal information (including at least the mane) included in the comparison result and the passenger information (name) stored in the passenger information storing part 43B are compared, and the name and seat position of the passenger that matched in the comparison and the getting-on passenger image picked up by the getting-on passenger camera 10 are associated. Consequently, when a passenger gets on a bus at the point of departure and the like, the picked-up image of the passenger getting on makes it possible to automatically associate the passenger with the passenger information (such as the name and seat position), even if a crew member does not directly check the name of the passenger getting on or a passenger ticket thereof.

Using the passenger management apparatus 1E, when a passenger who did not return by the expected time is detected, whether there is baggage of the passenger having not yet returned is judged on the basis of the information of baggage registered in the baggage information registering part 44. And when it is judged that there is baggage of the passenger having not yet returned, it is informed that the baggage of the passenger concerned should be checked or removed. Therefore, in case where the baggage of the passenger having not yet returned is a suspicious substance, it becomes possible to remove the baggage to the outside of the bus at once. The safety of the other passengers can be secured, and the occurrence of an accident by a suspicious substance can be prevented.

The present invention is not limited to the above embodiments. Various modifications can be made, and it is needless to say that those are also included in the scope of the present invention. And part of the constructions of the passenger management apparatuses and the processing operations thereof according to the embodiments (1)-(6) may be combined.

### INDUSTRIAL APPLICABILITY

The present invention relates to a passenger management apparatus and a passenger management method, that can be widely used for managing passengers of a transportation means which can transport a large number of people such as a bus.

### DESCRIPTION OF REFERENCE SIGNS

1, 1A, 1B, 1C, 1D, 1E: Passenger management apparatus
10, 11: Getting-on passenger camera
20, 21: Getting-off passenger camera
30: Clock section
40, 40A, 40B, 40C, 40D, 40E: Storage section
41, 41A, 41B: Getting-on passenger image storing part
42, 42A, 42B: Getting-off passenger image storing part
43, 43A, 43B: Passenger information storing part
50, 50A, 50B, 50C, 50D, 50E: Microcomputer
51a: Passenger number detecting part
51b: Passenger number informing part
52a: Getting-on/-off passenger comparing part
52b: Comparison result informing part
60: Display section
70, 70A, 70C, 70D: Communication section
80: Operating section

1. A passenger management apparatus for managing passengers of a transportation means which can transport a large number of people, comprising:
one or more getting-on passenger imaging parts for picking up an image of a passenger getting on;
one or more getting-off passenger imaging parts for picking up an image of a passenger getting off;
a getting-on passenger image storing part for associating to store the image including a face of the passenger getting on picked up by the getting-on passenger imaging part with the image's picked-up time;
a getting-off passenger image storing part for associating to store the image including a face of the passenger getting off picked up by the getting-off passenger imaging part with the image's picked-up time;
a passenger number detecting part for detecting the number of persons on board, on the basis of information stored in the getting-on passenger image storing part and the getting-off passenger image storing part;
a getting-on/-off passenger comparing part for comparing a passenger who got off after getting-on with a passenger getting on after getting-off, on the basis of the information stored in the getting-on passenger image storing part and the getting-off passenger image storing part;
a passenger number informing part for informing the number of passengers detected by the passenger number detecting part; and
a comparison result informing part for informing a result of comparison by the getting-on/-off passenger comparing part.

2. The passenger management apparatus according to claim 1, further comprising:
a biometric identification information acquiring part for acquiring biometric identification information of passengers, wherein
the getting-on passenger image storing part associates to store biometric identification information of the passenger getting on, as well as the image, with the image's picked-up time, and
the getting-off passenger image storing part associates to store biometric identification information of the passenger getting off, as well as the image, with the image's picked-up time.

3. The passenger management apparatus according to claim 1, further comprising:
a getting-on passenger stereoscopic image forming part for forming a stereoscopic image of the getting-on passenger using a plurality of images picked up from two or more directions by the getting-on passenger imaging parts; and
a getting-off passenger stereoscopic image forming part for forming a stereoscopic image of the getting-off passenger using a plurality of images picked up from two or more directions by the getting-off passenger imaging parts, wherein
the getting-on passenger image storing part associates to store the stereoscopic image of the getting-on passenger formed by the getting-on passenger stereoscopic image forming part with the images' picked-up time,
the getting-off passenger image storing part associates to store the stereoscopic image of the getting-off passenger formed by the getting-off passenger stereoscopic image forming part with the images' picked-up time, and
the getting-on/-off passenger comparing part compares the stereoscopic image of the passenger who got off after getting-on with the stereoscopic image of the passenger getting on after getting-off.

4. The passenger management apparatus according to claim 1, further comprising:
a passenger information associating part for associating the information stored in the getting-on passenger image storing part and the getting-off passenger image storing part, with passenger information including a name and a seat position of a passenger;
a vacant seat information detecting part for detecting the positions and number of vacant seats of the transportation means, on the basis of the information associated by the passenger information associating part;
a vacant seat information informing part for informing the positions and/or number of vacant seats detected by the vacant seat information detecting part;
a vacant seat number judging part for judging whether the number of vacant seats detected by the vacant seat information detecting part is correct in relation to the number of passengers detected by the passenger number detecting part; and
a judgment result informing part for informing a judgment result by the vacant seat number judging part.

5. The passenger management apparatus according to claim 4, further comprising:
a comparison instruction data sending part for sending comparison instruction data including the image picked up by the getting-on passenger imaging part to a passenger information database server in which passenger information including names, seat positions and face images of passengers is registered; and
a comparison result receiving part for receiving a comparison result of the image and the passenger information compared in the passenger information database server, wherein
the passenger information associating part associates the name and seat position of the passenger received from the passenger information database server with the image picked up by the getting-on passenger imaging part, when the comparison result shows a match.

6. The passenger management apparatus according to claim 4, further comprising:
a passenger information storing part for storing passenger information including a name and a seat position of a passenger;
a comparison instruction data sending part for sending comparison instruction data including the image picked up by the getting-on passenger imaging part to a personal information database server in which personal information including names and face images of individuals is registered; and
a comparison result receiving part for receiving a comparison result of the image and the personal information compared in the personal information database server, wherein
the passenger information associating part compares the name of an individual included in the comparison result when the comparison result shows a match, with the names of the passengers stored in the passenger information storing part and associates the name and seat position of the passenger that matched in the comparison with the image picked up by the getting-on passenger imaging part.

7. The passenger management apparatus according to claim 1, further comprising:
a request signal sending part for sending a position information request signal to a portable terminal device of a passenger who did not return by an expected time, on the basis of the comparison result by the getting-on/-off passenger comparing part;
a position information receiving part for receiving position information sent from the portable terminal device which received the position information request signal; and
a position information informing part for informing the received position information.

8. The passenger management apparatus according to claim 1, further comprising:
a position information receiving part for receiving position information sent from a portable terminal device of a passenger;
a return judging part for judging whether the passenger can return to the transportation means by an expected time on the basis of the received position information; and
a call signal sending part for sending a call signal, when it is judged that the passenger cannot return by the expected time by the return judging part, to the portable terminal device of the passenger who cannot return.

9. The passenger management apparatus according to claim 1, further comprising:
a baggage information registering part for registering information of baggage left by a passenger;
a baggage judging part for judging, when a passenger who did not return by an expected time is detected on the basis of a comparison result by the getting-on/-off passenger comparing part, whether there is baggage of the passenger who did not return by the expected time on the basis of the information of baggage registered in the baggage information registering part; and
a baggage informing part for informing, when it is judged that there is baggage of the passenger who did not return by the expected time by the baggage judging part, that the baggage of the passenger should be checked or removed.

10. The passenger management apparatus according to claim 1, further comprising:
a suspicious person comparison result informing part for informing, when the comparison result shows no match, a comparison result of the image including the face of the passenger with suspicious person image registration information; and
a reporting part for reporting to the outside when a result that the passenger with no match is a suspicious person is informed by the suspicious person comparison result informing part.

11. A passenger management method for managing passengers of a transportation means which can transport a large number of people, comprising the steps of:
picking up an image of a passenger getting on using one or more getting-on passenger imaging parts;
picking up an image of a passenger getting off using one or more getting-off passenger imaging parts;
associating to store the image including a face of the passenger getting on picked up by the getting-on passenger imaging part with the image's picked-up time in a getting-on passenger image storing part;
associating to store the image including a face of the passenger getting off picked up by the getting-off passenger imaging part with the image's picked-up time in a getting-off passenger image storing part;
detecting the number of passengers on board on the basis of information stored in the getting-on passenger image storing part and the getting-off passenger image storing part;
comparing a passenger who got off after getting-on with a passenger getting on after getting-off on the basis of the information stored in the getting-on passenger image storing part and the getting-off passenger image storing part;
informing the number of passengers detected in the step of detecting the number of passengers; and
informing a result of comparison in the step of comparing the getting-on/-off passengers.
